(19) United States
(12) Patent Application Publication
(10) Pub. No.: US 2026/0104653 A1
(43) Pub. Date: Apr. 16, 2026

(54) ELECTROPHOTOGRAPHIC PHOTORECEPTOR, PROCESS CARTRIDGE, AND IMAGE FORMING APPARATUS

(71) Applicant: FUJIFILM Business Innovation Corp., Tokyo (JP)

(72) Inventors: Masahiro IWASAKI, Kanagawa (JP); Yuki OYAMADA, Kanagawa (JP); Kenta IDE, Kanagawa (JP)

(73) Assignee: FUJIFILM Business Innovation Corp., Tokyo (JP)

(21) Appl. No.: 19/060,769

(22) Filed: Feb. 23, 2025

(30) Foreign Application Priority Data
Sep. 24, 2024 (JP) 2024-165670

(51) Int. Cl. G03G 5/047; G03G 5/06; G03G 5/087

(52) U.S. Cl. CPC G03G 5/047; G03G 5/0648; G03G 5/0651; G03G 5/087; G03G 2215/00957; G03G 2215/00962; G03G 2221/183

(57) ABSTRACT

An electrophotographic photoreceptor includes a conductive substrate, a first undercoat layer that is provided on the conductive substrate, a second undercoat layer that is provided on the first undercoat layer, and a photosensitive layer that is provided on the second undercoat layer, in which the first undercoat layer contains at least one electron transport material selected from the group consisting of a compound represented by Formula (1), a compound represented Formula (2), and a compound represented by Formula (3), and a binder resin, and a content of silica particles in the first undercoat layer is 0% by mass or 5% by mass or less, and the second undercoat layer contains at least one electron transport material selected from the group consisting of the compound represented by Formula (1), the compound represented Formula (2), and the compound represented by Formula (3), silica particles, and a binder resin, and a content of the silica particles in the second undercoat layer is larger than the content of the silica particles in the first undercoat layer.

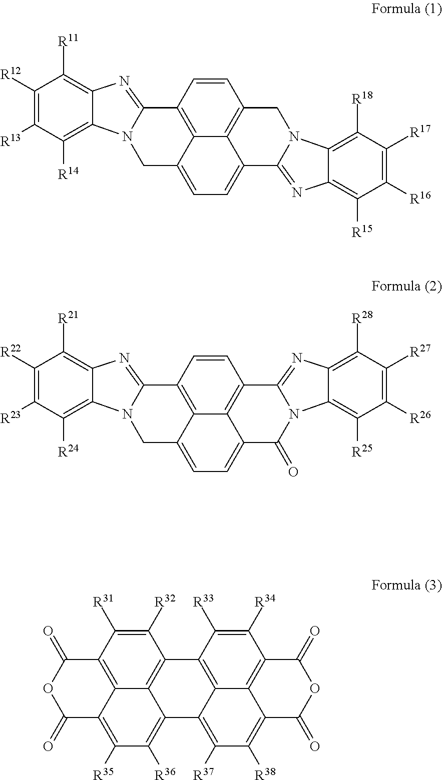

In Formula (1), R¹¹, R¹², R¹³, R¹⁴, R¹⁵, R¹⁶, R¹⁷, and R¹⁸ each independently represent a hydrogen atom, an alkyl group, an alkoxy group, an aralkyl group, an aryl group, an aryloxy group, an alkoxycarbonyl group, an aryloxycarbonyl group, an alkoxycarbonylalkyl group, an aryloxycarbonylalkyl group, or a halogen atom, R¹¹ and R¹², R¹² and R¹³, or R¹³ and R¹⁴ may be each independently linked to each other to form a ring, and R¹⁵ and R¹⁶, R¹⁶ and R¹⁷, or R¹⁷ and R¹⁸ may be each independently linked to each other to form a ring.

In Formula (2), R²¹, R²², R²³, R²⁴, R²⁵, R²⁶, R²⁷, and R²⁸ each independently represent a hydrogen atom, an alkyl group, an alkoxy group, an aralkyl group, an aryl group, an aryloxy group, an alkoxycarbonyl group, an aryloxycarbonyl group, an alkoxycarbonylalkyl group, an aryloxycarbonylalkyl group, or a halogen atom, R²¹ and R²², R²² and R²³, or R²³ and R²⁴ may be each independently linked to each other to form a ring, and R²⁵ and R²⁶, R²⁶ and R²⁷, or R²⁷ and R²⁸ may be each independently linked to each other to form a ring.

In Formula (3), R³¹, R³², R³³, R³⁴, R³⁵, R³⁶, R³⁷, and R³⁸ each independently represent a hydrogen atom, an alkyl group, an alkoxy group, an aralkyl group, an aryl group, an alkoxycarbonyl group, or a halogen atom.

### CROSS-REFERENCE TO RELATED APPLICATIONS

This application is based on and claims priority under 35 USC 119 from Japanese Patent Application No. 2024-165670 filed Sep. 24, 2024.

### BACKGROUND

### (i) Technical Field

The present invention relates an electrophotographic photoreceptor, a process cartridge, and an image forming apparatus.

### (ii) Related Art

JP1993-088396A discloses an electrophotographic photoreceptor including an interlayer between a conductive substrate and a photosensitive layer, in which the interlayer contains hydrophobic silica fine particles.

JP2016-138931A discloses an electrophotographic photoreceptor in which a support, an undercoat layer, a charge generation layer, and a hole transport layer are laminated in this order, in which the undercoat layer contains a polymerization substance of a composition containing an electron transport substance having a polar group selected from the group consisting of a hydroxy group, a thiol group, an amino group, a carboxy group, and a methoxy group, and a crosslinking agent, and contains silica particles, a content of the electron transport substance in the composition is 30% by mass or more and 70% by mass or less with respect to the total mass of the composition, and a content of the silica particles is 1% by mass or more and 30% by mass or less with respect to the total mass of the electron transport substance.

JP6946895B discloses an electrophotographic photoreceptor including a conductive substrate, an undercoat layer that is provided on the conductive substrate, contains an electron transport material and silica particles, and has a content of the silica particles of 30% by mass or more, and a photosensitive layer that is provided on the undercoat layer, in which a condensation rate of the silica particles is 90% or more, where the condensation rate is a rate of Si—O—Si in a bond of SiO₄— in the silica particles.

JP2003-330209A discloses an electrophotographic photoreceptor including an interlayer and a photosensitive layer in this order on a support, in which the interlayer contains a polymerization substance of an electron transport substance having a non-hydrolyzable polymerizable functional group.

JP2003-345044A discloses an electrophotographic photoreceptor including an interlayer and a photosensitive layer in this order on a support, in which the interlayer contains a specific resin.

JP5147274B discloses an electrophotographic photoreceptor containing a specific imide compound in an undercoat layer.

JP2011-095665A discloses an electrophotographic photoreceptor in which an interlayer and a photosensitive layer are provided in this order on a conductive support, in which the interlayer contains a specific polyolefin resin and an organic electron transport substance, and the organic electron transport substance is a compound selected from the group consisting of an imide-based compound, a benzimidazole-based compound, a quinone-based compound, a cyclopentadienylidene-based compound, an azo-based compound, and derivatives thereof.

JP3958154B discloses an electrophotographic photoreceptor including an interlayer and a photosensitive layer in this order on a support, in which the photosensitive layer contains a charge generation substance and a charge transport substance, an electrostatic latent image is formed on a surface of the electrophotographic photoreceptor using a semiconductor laser, the interlayer contains a specific electron transport material, a volume resistivity of the interlayer in an environment of 30° C. and 80% RH is 1×10¹² Ω·cm or more, and a ratio (Rz/λ) of a ten-point average roughness (Rz) of the surface of the support on the photosensitive layer side to a wavelength (λ) of the semiconductor laser is 0.6 or more and 2.5 or less.

### SUMMARY

In the related art, in a case where a foreign substance from the outside is stuck to a surface of an electrophotographic photoreceptor including an undercoat layer containing an electron transport material as an organic compound during image formation, leakage current tends to occur. In a case where the leakage current occurs, dot-like image defects are likely to occur. In a case where silica particles are highly uniformly dispersed in the undercoat layer in order to suppress the leakage current, residual potential tends to accumulate or charge retention property tends to deteriorate as an image is formed repeatedly.

Aspects of non-limiting embodiments of the present disclosure relate to an electrophotographic photoreceptor in which both accumulation of residual potential and leakage current are suppressed and charge retention property is excellent, as compared with a case where silica particles are highly uniformly contained in the entire region of an undercoat layer containing an electron transport material.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

Specific methods for achieving the above-described object include the following. Each formula is the same as the formula having the same number described later.

According to an aspect of the present disclosure, there is provided an electrophotographic photoreceptor including:
a conductive substrate;
a first undercoat layer that is provided on the conductive substrate;
a second undercoat layer that is provided on the first undercoat layer; and
a photosensitive layer that is provided on the second undercoat layer,
in which the first undercoat layer contains at least one electron transport material selected from the group consisting of a compound represented by Formula (1), a compound represented Formula (2), and a compound represented by Formula (3), and a binder resin, and a content of silica particles in the first undercoat layer is 0% by mass or 5% by mass or less, and
the second undercoat layer contains at least one electron transport material selected from the group consisting of the compound represented by Formula (1), the compound represented Formula (2), and the compound represented by Formula (3), silica particles, and a binder resin, and a content of the silica particles in the second undercoat layer is larger than the content of the silica particles in the first undercoat layer,

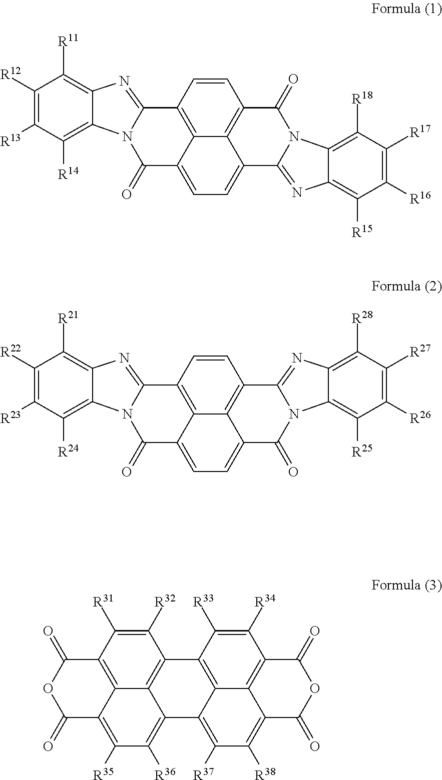

in Formula (1), R¹¹, R¹², R¹³, R¹⁴, R¹⁵, R¹⁶, R¹⁷, and R¹⁸ each independently represent a hydrogen atom, an alkyl group, an alkoxy group, an aralkyl group, an aryl group, an aryloxy group, an alkoxycarbonyl group, an aryloxycarbonyl group, an alkoxycarbonylalkyl group, an aryloxycarbonylalkyl group, or a halogen atom, R¹¹ and R¹², R¹² and R¹³, or R¹³ and R¹⁴ may be each independently linked to each other to form a ring, and R¹⁵ and R¹⁶, R¹⁶ and R¹⁷, or R¹⁷ and R¹⁸ may be each independently linked to each other to form a ring,
in Formula (2), R²¹, R²², R²³, R²⁴, R²⁵, R²⁶, R²⁷, and R²⁸ each independently represent a hydrogen atom, an alkyl group, an alkoxy group, an aralkyl group, an aryl group, an aryloxy group, an alkoxycarbonyl group, an aryloxycarbonyl group, an alkoxycarbonylalkyl group, an aryloxycarbonylalkyl group, or a halogen atom, R²¹ and R²², R²² and R²³, or R²³ and R²⁴ may be each independently linked to each other to form a ring, and R²⁵ and R²⁶, R²⁶ and R²⁷, or R²⁷ and R²⁸ may be each independently linked to each other to form a ring,
in Formula (3), R³¹, R³², R³³, R³⁴, R³⁵, R³⁶, R³⁷, and R³⁸ each independently represent a hydrogen atom, an alkyl group, an alkoxy group, an aralkyl group, an aryl group, an alkoxycarbonyl group, or a halogen atom.

### BRIEF DESCRIPTION OF THE DRAWINGS

Exemplary embodiment(s) of the present invention will be described in detail based on the following figures, wherein:

FIG. 1 is a partial cross-sectional view showing an example of a layer configuration of an electrophotographic photoreceptor according to the present exemplary embodiment;

FIG. 2 is a partial cross-sectional view showing another example of the layer configuration of the electrophotographic photoreceptor according to the present exemplary embodiment;

FIG. 3 is a view schematically showing the configuration of an example of an image forming apparatus according to the present exemplary embodiment; and

FIG. 4 is a view schematically showing a configuration of another example of the image forming apparatus according to the present exemplary embodiment.

### DETAILED DESCRIPTION

The exemplary embodiments of the present disclosure will be described below. The following descriptions and examples merely illustrate the exemplary embodiments, and do not limit the scope of the exemplary embodiments.

In the present disclosure, a numerical range described using “to” represents a range including numerical values listed before and after “to” as the minimum value and the maximum value respectively.

Regarding the numerical ranges described in stages in the present disclosure, the upper limit or lower limit of a numerical range may be replaced with the upper limit or lower limit of another numerical range described in stages. Furthermore, in the present disclosure, the upper limit or lower limit of a numerical range may be replaced with values described in examples.

In the present disclosure, the term “step” includes not only an independent step but a step that is not clearly distinguished from other steps as long as the purpose of the step is achieved.

In the present disclosure, in a case where an exemplary embodiment is described with reference to drawings, the configuration of the exemplary embodiment is not limited to the configuration shown in the drawings. In addition, the sizes of members in each drawing are conceptual and do not limit the relative relationship between the sizes of the members.

In the present disclosure, each component may include a plurality of corresponding substances. In a case where the amount of each component in a composition is mentioned in the present disclosure, and there are two or more kinds of substances corresponding to each component in the composition, unless otherwise specified, the amount of each component means the total amount of two or more kinds of the substances present in the composition.

In the present disclosure, each component may include two or more kinds of corresponding particles. In a case where there are two or more kinds of particles corresponding to each component in a composition, unless otherwise specified, the particle size of each component means a value for a mixture of two or more kinds of the particles present in the composition.

In the present disclosure, an alkyl group and an alkylene group are any of linear, branched, or cyclic, unless otherwise specified.

In the present disclosure, a hydrogen atom in an organic group, an aromatic ring, a linking group, an alkyl group, an alkylene group, an aryl group, an aralkyl group, an alkoxy group, an aryloxy group, and the like may be substituted with a halogen atom.

In the present disclosure, in a case where a compound is represented by a structural formula, the compound may be represented by a structural formula in which symbols representing a carbon atom and a hydrogen atom (C and H) in a hydrocarbon group and/or a hydrocarbon chain are omitted.

In the present disclosure, “constitutional unit” of a copolymer or a resin is the same as a monomer unit.

### Electrophotographic Photoreceptor

Hereinafter, an electrophotographic photoreceptor will be simply referred to as “photoreceptor”.

Hereinafter, in a case where common matters between a first exemplary embodiment and a second exemplary embodiment are described, the exemplary embodiments will be referred to as “present exemplary embodiment”.

Hereinafter, a compound represented by Formula (1) is also referred to as a perinone compound (1), a compound represented by Formula (2) is also referred to as a perinone compound (2), and a compound represented by Formula (3) is also referred to as perylenetetracarboxylic acid dianhydride.

The photoreceptor according to a first exemplary embodiment includes a conductive substrate, a first undercoat layer provided on the conductive substrate, a second undercoat layer provided on the first undercoat layer, and a photosensitive layer provided on the second undercoat layer.

The first undercoat layer contains at least one electron transport material selected from the group consisting of the compound represented by Formula (1), the compound represented by Formula (2), and the compound represented by Formula (3), and a binder resin, and a content of silica particles in the first undercoat layer is 0% by mass or 5% by mass or less.

The second undercoat layer contains at least one electron transport material selected from the group consisting of the compound represented by Formula (1), the compound represented by Formula (2), and the compound represented by Formula (3), silica particles, and a binder resin, and a content of the silica particles in the second undercoat layer is larger than the content of the silica particles in the first undercoat layer.

The photoreceptor according to a second exemplary embodiment includes a conductive substrate, a specific undercoat layer provided on the conductive substrate, and a photosensitive layer provided on the specific undercoat layer.

The specific undercoat layer contains at least one electron transport material selected from the group consisting of the compound represented by Formula (1), the compound represented by Formula (2), and the compound represented by Formula (3), silica particles, and a binder resin, and the silica particles are unevenly distributed in a region within 50% in a direction of the conductive substrate from an interface between the specific undercoat layer and the photosensitive layer.

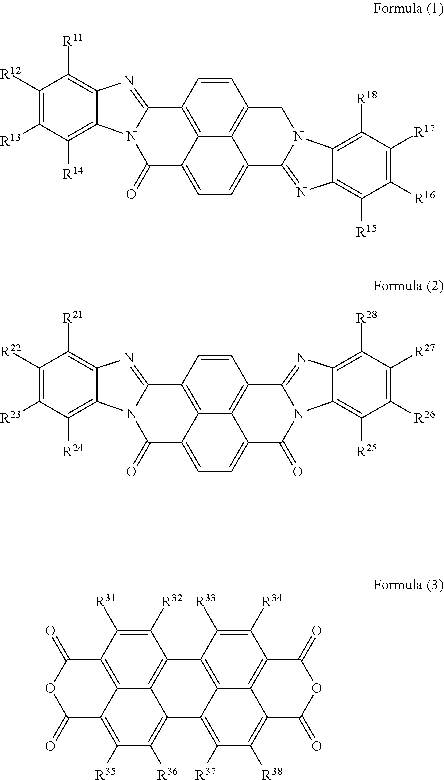

In Formula (1), R¹¹, R¹², R¹³, R¹⁴, R¹⁵, R¹⁶, R¹⁷, and R¹⁸ each independently represent a hydrogen atom, an alkyl group, an alkoxy group, an aralkyl group, an aryl group, an aryloxy group, an alkoxycarbonyl group, an aryloxycarbonyl group, an alkoxycarbonylalkyl group, an aryloxycarbonylalkyl group, or a halogen atom, R¹¹ and R¹², R¹² and R¹³, or R¹³ and R¹⁴ may be each independently linked to each other to form a ring, and R¹⁵ and R¹⁶, R¹⁶ and R¹⁷, or R¹⁷ and R¹⁸ may be each independently linked to each other to form a ring.

In Formula (2), R²¹, R²², R²³, R²⁴, R²⁵, R²⁶, R²⁷, and R²⁸ each independently represent a hydrogen atom, an alkyl group, an alkoxy group, an aralkyl group, an aryl group, an aryloxy group, an alkoxycarbonyl group, an aryloxycarbonyl group, an alkoxycarbonylalkyl group, an aryloxycarbonylalkyl group, or a halogen atom, R²¹ and R²², R²² and R²³, or R²³ and R²⁴ may be each independently linked to each other to form a ring, and R²⁵ and R²⁶, R²⁶ and R²⁷, or R²⁷ and R²⁸ may be each independently linked to each other to form a ring.

In Formula (3), R³¹, R³², R³³, R³⁴, R³⁵, R³⁶, R³⁷, and R³⁸ each independently represent a hydrogen atom, an alkyl group, an alkoxy group, an aralkyl group, an aryl group, an alkoxycarbonyl group, or a halogen atom.

In the related art, it is known that a photoreceptor in which the compound represented by Formula (1) and/or the compound represented by Formula (2) is used as a charge transport material in an undercoat layer can exhibit favorable initial electrical properties. In addition, as a result of intensive studies by the inventors, it is found that a photoreceptor in which the compound represented by Formula (3) is used in an undercoat layer also has excellent initial electrical properties.

However, in a case where a foreign substance (for example, needle-like foreign substance such as carbon fiber) from the outside is stuck to a surface of these photoreceptors during image formation, the foreign substance tends to penetrate through the conductive substrate and generate leakage current.

In a case where silica particles are highly uniformly dispersed in the undercoat layer containing the above-described charge transport material in order to suppress the leakage current, the silica particles are made to have low resistance by a polar group such as a hydroxyl group on the silica surface; and in a case where an image is formed repeatedly, charge retention property tends to gradually decrease due to repeated exposure and electrification. In addition, in a case of silica particles subjected to a treatment such as hydrophobization on the surface, the resistance is increased, and thus the charge retention property is improved. However, since the silica particles do not contribute to charge transport properties, a conductive path of the charge transport material is inhibited, and residual potential tends to increase because sufficient charge transport cannot be performed to the conductive substrate.

On the other hand, the photoreceptor according to the present exemplary embodiment has the above-described configuration, and thus suppresses both accumulation of the residual potential and the leakage current and has excellent charge retention property. The mechanism is not necessarily clear, but is presumed as follows.

In the first exemplary embodiment, the second undercoat layer on the photosensitive layer side has a higher content of silica particles than the first undercoat layer on the conductive substrate side. That is, the silica particles are largely biased to the interface side with the photosensitive layer in the entire undercoat layer. Therefore, even in a case where the foreign substance is stuck to the surface of the photoreceptor, penetration of the foreign substance into the conductive substrate is suppressed, and the leakage current to the conductive substrate is suppressed. In addition, since the content of the silica particles in the first undercoat layer is 0% by mass or 5% by mass or less, a contact area between the conductive substrate and the charge transport material is sufficiently maintained even in a case where an image is formed repeatedly, and thus the charge transport to the conductive substrate is sufficiently maintained, and the accumulation of the residual potential is suppressed. That is, the inhibition of the conductive path of the charge transport material by the silica particles is less likely to occur. In addition, both the first undercoat layer and the second undercoat layer contain at least one selected from the group consisting of the compounds represented by Formulae (1) to (3), as a charge transport material having excellent charge retention property. In this manner, sufficient charge transport properties and charge retention properties are maintained.

In the specific undercoat layer according to the second exemplary embodiment, the silica particles are unevenly distributed in the region within 50% in the direction of the conductive substrate from the interface between the specific undercoat layer and the photosensitive layer. Therefore, even in a case where the foreign substance is stuck to the surface of the photoreceptor, the foreign substance is likely to remain at the interface between the specific undercoat layer and the photosensitive layer, penetration of the foreign substance into the conductive substrate is suppressed, and the local leakage current is suppressed. In addition, even in a case where an image is formed repeatedly, the accumulation of the residual potential is suppressed, and the inhibition of the conductive path of the charge transport material by the silica particles is less likely to occur. In addition, the entire specific undercoat layer contains at least one selected from the group consisting of the compounds represented by Formulae (1) to (3), as a charge transport material having excellent charge retention property. In this manner, both charge transport properties and charge retention properties are maintained.

Hereinafter, a layer configuration of the photoreceptor according to the present exemplary embodiment will be described with reference to the drawing.

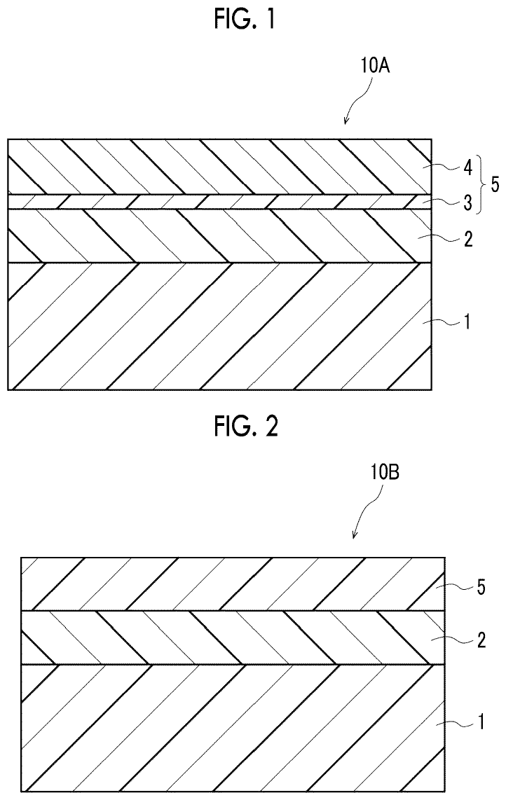

FIG. 1 is a partial cross-sectional view schematically showing an example of a layer configuration of the photoreceptor according to the present exemplary embodiment. A photoreceptor 10A shown in FIG. 1 includes a lamination-type photosensitive layer. The photoreceptor 10A has a structure in which an undercoat layer 2, a charge generation layer 3, and a charge transport layer 4 are laminated in this order on a conductive substrate 1, and the charge generation layer 3 and the charge transport layer 4 constitute a photosensitive layer 5 (so-called function separation-type photosensitive layer). The photoreceptor 10A may include an interlayer (not shown) between the undercoat layer 2 and the charge generation layer 3.

In the case of the photoreceptor according to the first exemplary embodiment, the undercoat layer 2 shown in FIG. 1 has a two-layered configuration in which the first undercoat layer and the second undercoat layer are laminated in this order from the conductive substrate 1 side. It is sufficient that the second undercoat layer is provided on at least a part of a region of the first undercoat layer, and the second undercoat layer may be provided on the entire surface of the first undercoat layer.

In the case of the photoreceptor according to the second exemplary embodiment, the undercoat layer 2 shown in FIG. 1 is the specific undercoat layer.

FIG. 2 is a partial cross-sectional view schematically showing another example of the layer configuration of the photoreceptor according to the present exemplary embodiment. A photoreceptor 10B shown in FIG. 2 includes a single layer-type photosensitive layer. The photoreceptor 10B has a structure in which the undercoat layer 2 and the photosensitive layer 5 are laminated in this order on the conductive substrate 1. The photoreceptor 10B may include an interlayer (not shown) between the undercoat layer 2 and the photosensitive layer 5.

In the case of the photoreceptor according to the first exemplary embodiment, the undercoat layer 2 shown in FIG. 2 has a two-layered configuration in which the first undercoat layer and the second undercoat layer are laminated in this order from the conductive substrate 1 side. It is sufficient that the second undercoat layer is provided on at least a part of a region of the first undercoat layer, and the second undercoat layer may be provided on the entire surface of the first undercoat layer.

In the case of the photoreceptor according to the second exemplary embodiment, the undercoat layer 2 shown in FIG. 2 is the specific undercoat layer.

Hereinafter, each layer of the electrophotographic photoreceptor according to the present exemplary embodiment will be described in detail. The reference numerals will not be provided.

### Undercoat Layer

In the first exemplary embodiment, the undercoat layer has a two-layered configuration of the first undercoat layer provided on the conductive substrate and the second undercoat layer provided on the first undercoat layer.

In the second exemplary embodiment, the undercoat layer includes the specific undercoat layer provided on the conductive substrate.

The first undercoat layer contains at least one electron transport material selected from the group consisting of the compound represented by Formula (1), the compound represented by Formula (2), and the compound represented by Formula (3), and a binder resin, and the content of silica particles in the first undercoat layer is 0% by mass or 5% by mass or less.

In the first undercoat layer, the content of silica particles in the first undercoat layer is 0% by mass or 5% by mass or less, for example, preferably 0% by mass or 3% by mass or less, more preferably 0% by mass or 2% by mass or less, and still more preferably 0% by mass. In a case where the content of the silica particles in the first undercoat layer is 0% by mass or 5% by mass or less, the conductive path of the electron transport material is less likely to be inhibited, and injection of charges from the conductive substrate is suppressed during charging, that is excellent in charge retention property. In addition, the accumulation of the residual potential is suppressed.

The second undercoat layer contains at least one electron transport material selected from the group consisting of the compound represented by Formula (1), the compound represented by Formula (2), and the compound represented by Formula (3), silica particles, and a binder resin, and the content of the silica particles in the second undercoat layer is larger than the content of the silica particles in the first undercoat layer.

In the second undercoat layer, for example, the content of the silica particles in the second undercoat layer is preferably 20% by mass or more, more preferably 20% by mass or more and 50% by mass or less, and still more preferably 25% by mass or more and 45% by mass or less.

In a case where the content of the silica particles in the second undercoat layer is 20% by mass or more, even in a case where the foreign substance is stuck to the photoreceptor, the penetration into the conductive substrate is suppressed, and the leakage current is further suppressed.

In a case where the content of the silica particles in the second undercoat layer is 50% by mass or less, the conductive path of the electron transport material is less likely to be inhibited, and the charge retention property is more excellent. In addition, even in a case where the foreign substance is stuck to the photoreceptor, the penetration into the conductive substrate is suppressed, and thus suppression of the leakage current is excellent.

The specific undercoat layer contains at least one electron transport material selected from the group consisting of the compound represented by Formula (1), the compound represented by Formula (2), and the compound represented by Formula (3), silica particles, and a binder resin, and the silica particles are unevenly distributed in the region within 50% in the direction of the conductive substrate from the interface between the specific undercoat layer and the photosensitive layer.

In the cross section in the thickness direction of the specific undercoat layer, the proportion of the silica particles in the region within 50% in the direction of the conductive substrate from the interface between the specific undercoat layer and the photosensitive layer is, for example, preferably 25% by area or more and 60% by area or less, more preferably 30% by area or more and 50% by area or less, and still more preferably 35% by area or more and 45% by area or less with respect to the entire specific undercoat layer.

In the specific undercoat layer, a content of the silica particles in a region exceeding 50% in the direction of the conductive substrate from the interface between the specific undercoat layer and the photosensitive layer is, for example, preferably 0% by mass or 5% by mass or less, more preferably 0% by mass or 3% by mass or less, still more preferably 0% by mass or 2% by mass or less, and even more preferably 0% by mass. In a case where the content of the silica particles in the above-described region exceeding 50% is 0% by mass or 5% by mass or less, the conductive path of the electron transport material is less likely to be inhibited, and the accumulation of the residual potential is suppressed.

In the specific undercoat layer, a content of the silica particles in a region within 50% in the direction of the conductive substrate from the interface between the specific undercoat layer and the photosensitive layer is, for example, preferably 5% by mass or less, more preferably 0% by mass or 3% by mass or less, still more preferably 0% by mass or 2% by mass or less, and even more preferably 0% by mass. In a case where the content of the silica particles in the above-described region exceeding 50% is 5% by mass or less, the conductive path of the electron transport material is less likely to be inhibited, and the accumulation of the residual potential is suppressed.

Each area ratio of the silica particles is measured by the following method. First, an undercoat layer obtained by peeling off the photosensitive layer and the like from the photoreceptor is cut in the thickness direction. The obtained cut surface is observed with a scanning electron microscope (SEM). In the cut surface, a cross-sectional area S1 of the region within 50% in the direction of the conductive substrate from the interface between the specific undercoat layer and the photosensitive layer, a sum P1 of cross-sectional areas of all silica particles observed in the region within 50%, a cross-sectional area S2 of the region exceeding 50% in the direction of the conductive substrate from the interface between the specific undercoat layer and the photosensitive layer, and a sum P2 of cross-sectional areas of all silica particles observed in the region exceeding 50% are obtained, and a ratio of the cross-sectional area P to the cross-sectional area S of the silica particles is obtained.

In each of the first exemplary embodiment and the second exemplary embodiment, the total amount of the electron transport material in the undercoat layer (that is, the total amount of the electron transport material in the entire undercoat layer including the first undercoat layer and the second undercoat layer in the first exemplary embodiment, or the total amount of the electron transport material in the specific undercoat layer in the second exemplary embodiment) is, for example, preferably 50% by mass or more and 75% by mass or less, more preferably 55% by mass or more and 70% by mass or less, and still more preferably 60% by mass or more and 65% by mass or less with respect to the solid content excluding the content of the silica particles in the undercoat layer.

In a case where the content of the electron transport material is 75% by mass or less, degradation of the film quality, a decrease in film forming properties, and occurrence of surface roughness on the undercoat layer are suppressed, and thus the charge retention property is more excellent.

On the other hand, in a case where the content of the electron transport material is 50% by mass or more, sufficient electron transportability is exhibited, and thus the accumulation of the residual potential is suppressed and the charge retention property is sufficiently ensured.

A film thickness of the first undercoat layer is, for example, preferably 1 μm or more and 20 μm or less, more preferably 2 μm or more and 10 μm or less, and still more preferably 2 μm or more and 6 μm or less.

A film thickness of the second undercoat layer is, for example, preferably 1 μm or more and 20 μm or less, more preferably 1 μm or more and 10 μm or less, and still more preferably 1 μm or more and 5 μm or less.

A film thickness of the specific undercoat layer is, for example, preferably 1 μm or more and 20 μm or less, more preferably 2 μm or more and 15 μm or less, and still more preferably 2 μm or more and 10 μm or less.

Hereinafter, common aspects in the first undercoat layer, the second undercoat layer, and the specific undercoat layer will be described.

Hereinafter, in a case of common matters to the first undercoat layer, the second undercoat layer, and the specific undercoat layer, the term “undercoat layer” will be simply used.

### Silica Particles

Examples of the silica particles include dry silica particles and wet silica particles. The silica particles may be used alone or in combination of two or more kinds thereof.

Examples of the dry silica particles include silica by a combustion method (fumed silica) obtained by combustion of a silane compound and silica by a deflagration method obtained by explosive combustion of metallic silicon powder.

Examples of the wet silica particles include wet silica particles obtained by a neutralization reaction between sodium silicate and a mineral acid (silica by a precipitation method synthesized and aggregated under alkaline conditions, silica particles by a gelation method synthesized and aggregated under acidic conditions), colloidal silica particles (silica sol particles) obtained by alkalifying and polymerizing acidic silicate, and sol-gel silica particles obtained by the hydrolysis of an organic silane compound (for example, alkoxysilane).

The silica particles may have a surface subjected to a surface treatment with a hydrophobic agent. Examples of the hydrophobic agent include known silane compounds such as chlorosilane, alkoxysilane, and silazane.

As the hydrophobic agent, for example, a silane compound having a trimethylsilyl group, a decylsilyl group, or a phenylsilyl group is preferable. That is, for example, it is preferable that the surface of the silica particles has a trimethylsilyl group, a decylsilyl group, or a phenylsilyl group.

Examples of the silane compound having a trimethylsilyl group include trimethylchlorosilane, trimethylmethoxysilane, and 1,1,1,3,3,3-hexamethyldisilazane. Examples of the silane compound having a decylsilyl group include decyltrichlorosilane, decyldimethylchlorosilane, and decyltrimethoxysilane. Examples of the silane compound having a phenyl group include triphenylmethoxysilane and triphenylchlorosilane.

An average primary particle size of the silica particles is, for example, preferably 50 nm or more and 500 nm or less, more preferably 60 nm or more and 400 nm or less, and still more preferably 70 nm or more and 300 nm or less.

In a case where the average primary particle size of the silica particles is 50 nm or more, even in a case where the foreign substance is stuck to the surface of the photoreceptor, the penetration of the foreign substance from the undercoat layer to the conductive substrate is suppressed. As a result, the leakage current is further suppressed.

In a case where the average primary particle size of the silica particles is 500 nm or less, even in a case where the foreign substance is stuck to the surface of the photoreceptor, the penetration of the foreign substance from the undercoat layer to the conductive substrate is suppressed.

The average primary particle size of the silica particles is obtained by the following measuring method.

The average primary particle size of the silica particles is measured by the following method. First, an undercoat layer obtained by peeling off the photosensitive layer and the like from the photoreceptor is cut in the thickness direction. The obtained cut surface is observed with a scanning electron microscope (SEM). For the surface silica particles observed on the cut surface, a diameter of a circle (that is, an equivalent circle diameter) equal to any 50 areas is used as a particle diameter, and an arithmetic average value thereof is defined as the average primary particle size.

### Inorganic Particles Other Than Silica Particles

In the undercoat layer, a proportion of inorganic particles other than the silica particles in the undercoat layer is, for example, preferably 10% by mass or less, more preferably 5% by mass or less, and still more preferably 0% by mass or 3% by mass or less.

In a case where the proportion of the inorganic particles other than the silica particles in the undercoat layer is 10% by mass or less, a decrease in resistance due to the inorganic particles is suppressed, the charge retention property is more excellent, and the image quality defect can be suppressed.

### Electron Transport Material

The electron transport material includes at least one selected from the group consisting of the compound represented by Formula (1), the compound represented by Formula (2), and the compound represented by Formula (3).

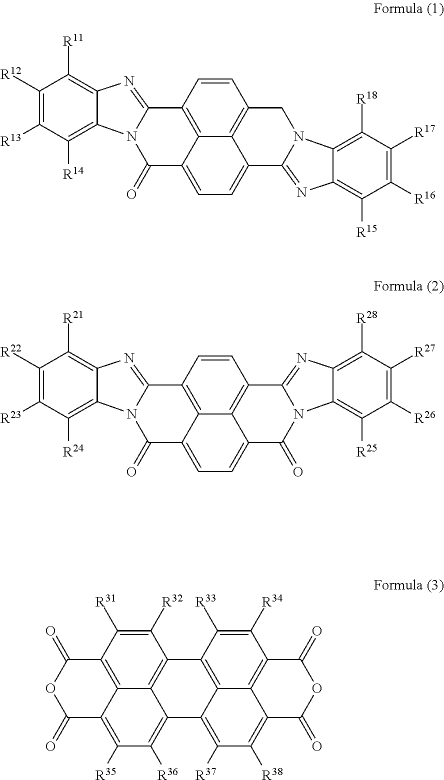

In Formula (1), R¹¹, R¹², R¹³, R¹⁴, R¹⁵, R¹⁶, R¹⁷, and R¹⁸ each independently represent a hydrogen atom, an alkyl group, an alkoxy group, an aralkyl group, an aryl group, an aryloxy group, an alkoxycarbonyl group, an aryloxycarbonyl group, an alkoxycarbonylalkyl group, an aryloxycarbonylalkyl group, or a halogen atom, R¹¹ and R¹², R¹² and R¹³, or R¹³ and R¹⁴ may be each independently linked to each other to form a ring, and R¹⁵ and R¹⁶, R¹⁶ and R¹⁷, or R¹⁷ and R¹⁸ may be each independently linked to each other to form a ring.

In Formula (2), R²¹, R²², R²³, R²⁴, R²⁵, R²⁶, R²⁷, and R²⁸ each independently represent a hydrogen atom, an alkyl group, an alkoxy group, an aralkyl group, an aryl group, an aryloxy group, an alkoxycarbonyl group, an aryloxycarbonyl group, an alkoxycarbonylalkyl group, an aryloxycarbonylalkyl group, or a halogen atom, R²¹ and R²², R²² and R²³, or R²³ and R²⁴ may be each independently linked to each other to form a ring, and R²⁵ and R²⁶, R²⁶ and R²⁷, or R²⁷ and R²⁸ may be each independently linked to each other to form a ring.

In Formula (3), R³¹, R³², R³³, R³⁴, R³⁵, R³⁶, R³⁷, and R³⁸ each independently represent a hydrogen atom, an alkyl group, an alkoxy group, an aralkyl group, an aryl group, an alkoxycarbonyl group, or a halogen atom.

From the viewpoint of accumulating the residual potential and suppressing the leakage current, and from the viewpoint of further improving the charge retention property, for example, the electron transport material preferably includes at least one selected from the group consisting of the compound represented by Formula (1), the compound represented by Formula (2), and the compound represented by Formula (3). Here, in Formula (1), R¹¹, R¹², R¹³, R¹⁴, R¹⁵, R¹⁶, R¹⁷, and R¹⁸ each independently represent a hydrogen atom, an alkyl group, or a halogen atom, in Formula (2), R²¹, R²², R²³, R²⁴, R²⁵, R²⁶, R²⁷, and R²⁸ each independently represent a hydrogen atom, an alkyl group, or a halogen atom, and in Formula (3), R³¹, R³², R³³, R³⁴, R³⁵, R³⁶, R³⁷, and R³⁸ each independently represent a hydrogen atom, an alkyl group, or a halogen atom.

Perinone Compound (1) and Perinone Compound (2)

The perinone compound (1) is the compound represented by Formula (1).

The perinone compound (2) is the compound represented by Formula (2).

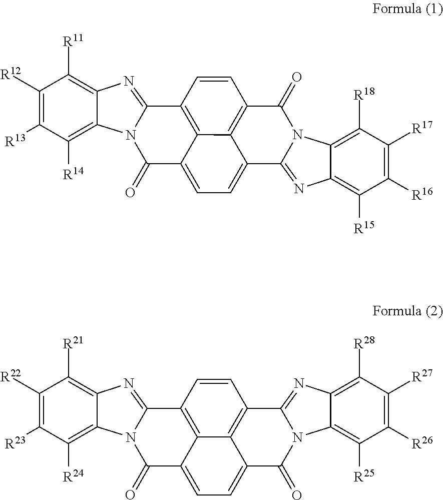

In Formula (1), R¹¹, R¹², R¹³, R¹⁴, R¹⁵, R¹⁶, R¹⁷, and R¹⁸ each independently represent a hydrogen atom, an alkyl group, an alkoxy group, an aralkyl group, an aryl group, an aryloxy group, an alkoxycarbonyl group, an aryloxycarbonyl group, an alkoxycarbonylalkyl group, an aryloxycarbonylalkyl group, or a halogen atom, R¹¹ and R¹², R¹² and R¹³, or R¹³ and R¹⁴ may be each independently linked to each other to form a ring, and R¹⁵ and R¹⁶, R¹⁶ and R¹⁷, or R¹⁷ and R¹⁸ may be each independently linked to each other to form a ring.

In Formula (2), R²¹, R²², R²³, R²⁴, R²⁵, R²⁶, R²⁷, and R²⁸ each independently represent a hydrogen atom, an alkyl group, an alkoxy group, an aralkyl group, an aryl group, an aryloxy group, an alkoxycarbonyl group, an aryloxycarbonyl group, an alkoxycarbonylalkyl group, an aryloxycarbonylalkyl group, or a halogen atom, R²¹ and R²², R²² and R²³, or R²³ and R²⁴ may be each independently linked to each other to form a ring, and R²⁵ and R²⁶, R²⁶ and R²⁷, or R²⁷ and R²⁸ may be each independently linked to each other to form a ring.

The compound represented by Formulae (1) and (2) has excellent electron transport properties and low hole transport properties. Therefore, in a case where the undercoat layer contains the compound represented by Formulae (1) and (2), the undercoat layer has excellent electron transport properties, the conductive path in the undercoat layer is likely to be secured, and leakage current is further suppressed. In addition, the charge retention property is more excellent because the dark decay is further reduced.

In Formula (1), for example, R¹¹, R¹², R¹³, R¹⁴, R¹⁵, R¹⁶, R¹⁷, and R¹⁸ each independently preferably represent a hydrogen atom, an alkyl group, or a halogen atom, and more preferably represent a hydrogen atom.

In Formula (1), in a case where R¹¹ to R¹⁸ are a hydrogen atom, an alkyl group, or a halogen atom (for example, more preferably a hydrogen atom), the undercoat layer has excellent electron transport properties, the conductive path in the undercoat layer is easily secured, and the leakage current is further suppressed. In addition, the charge retention property is more excellent because the dark decay is further reduced.

In Formula (2), for example, R²¹, R²², R²³, R²⁴, R²⁵, R²⁶, R²⁷, and R²⁸ each independently preferably represent a hydrogen atom, an alkyl group, or a halogen atom, and more preferably represent a hydrogen atom.

In Formula (2), in a case where R²¹ to R²⁸ are a hydrogen atom, an alkyl group, or a halogen atom (for example, more preferably a hydrogen atom), the undercoat layer has excellent electron transport properties, the conductive path in the undercoat layer is easily secured, and the leakage current is further suppressed. In addition, the charge retention property is more excellent because the dark decay is further reduced.

Examples of the alkyl group represented by R¹¹ to R¹⁸ in Formula (1) include a substituted or unsubstituted alkyl group.

Examples of the unsubstituted alkyl group represented by R¹¹ to R¹⁸ in Formula (1) include a linear alkyl group having 1 or more and 20 or less carbon atoms (for example, preferably having 1 or more and 10 or less carbon atoms and more preferably having 1 or more and 6 or less carbon atoms), a branched alkyl group having 3 or more and 20 or less carbon atoms (for example, preferably having 3 or more and 10 or less carbon atoms), and a cyclic alkyl group having 3 or more and 20 or less carbon atoms (for example, preferably having 3 or more and 10 or less carbon atoms).

Examples of the linear alkyl group having 1 or more and 20 or less carbon atoms include a methyl group, an ethyl group, an n-propyl group, an n-butyl group, an n-pentyl group, an n-hexyl group, an n-heptyl group, an n-octyl group, an n-nonyl group, an n-decyl group, an n-undecyl group, an n-dodecyl group, a tridecyl group, an n-tetradecyl group, an n-pentadecyl group, an n-heptadecyl group, an n-octadecyl group, an n-nonadecyl group, and an n-icosyl group.

Specific examples of the branched alkyl group having 3 or more and 20 or less carbon atoms include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, a tert-decyl group, an isododecyl group, a sec-dodecyl group, a tert-dodecyl group, a tert-tetradecyl group, and a tert-pentadecyl group.

Examples of the cyclic alkyl group having 3 or more and 20 or less carbon atoms include a cyclopropyl group, a cyclobutyl group, a cyclopentyl group, a cyclohexyl group, a cycloheptyl group, a cyclooctyl group, a cyclononyl group, a cyclodecyl group, and the like, and a polycyclic (for example, bicyclic, tricyclic, or spirocyclic) alkyl group composed of these monocyclic alkyl groups linked to each other.

Among the above, for example, a linear alkyl group such as a methyl group and an ethyl group is preferable as the unsubstituted alkyl group.

Examples of the substituent in the alkyl group include an alkoxy group, a hydroxy group, a carboxy group, a nitro group, and a halogen atom (such as a fluorine atom, a bromine atom, and an iodine atom).

Examples of the alkoxy group that substitutes the hydrogen atom in the alkyl group include the same groups as the groups for the unsubstituted alkoxy group represented by R¹¹ to R¹⁸ in Formula (1).

Examples of the alkoxy group represented by R¹¹ to R¹⁸ in Formula (1) include a substituted or unsubstituted alkoxy group.

Examples of the unsubstituted alkoxy group represented by R¹¹ to R¹⁸ in Formula (1) include a linear, branched, or cyclic alkoxy group having 1 or more and 10 or less carbon atoms (for example, preferably having 1 or more and 6 or less carbon atoms, and more preferably having 1 or more and 4 or less carbon atoms).

Specific examples of the linear alkoxy group include a methoxy group, an ethoxy group, an n-propoxy group, an n-butoxy group, an n-pentyloxy group, an n-hexyloxy group, an n-heptyloxy group, an n-octyloxy group, an n-nonyloxy group, and an n-decyloxy group.

Specific examples of the branched alkoxy group include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, a tert-hexyloxy group, an isoheptyloxy group, a sec-heptyloxy group, a tert-heptyloxy group, an isooctyloxy group, a sec-octyloxy group, a tert-octyloxy group, an isononyloxy group, a sec-nonyloxy group, a tert-nonyloxy group, an isodecyloxy group, a sec-decyloxy group, and a tert-decyloxy group.

Specific examples of the cyclic alkoxy group include a cyclopropoxy group, a cyclobutoxy group, a cyclopentyloxy group, a cyclohexyloxy group, a cycloheptyloxy group, a cyclooctyloxy group, a cyclononyloxy group, and a cyclodecyloxy group.

Among the above, for example, a linear alkoxy group is preferable as the unsubstituted alkoxy group.

Examples of the substituent in the alkoxy group include an aryl group, an alkoxycarbonyl group, an aryloxycarbonyl group, a hydroxyl group, a carboxy group, a nitro group, and a halogen atom (such as a fluorine atom, a bromine atom, and an iodine atom).

Examples of the aryl group that substitutes the hydrogen atom in the alkoxy group include the same groups as the groups for the unsubstituted aryl group represented by R¹¹ to R¹⁸ in Formula (1).

Examples of the alkoxycarbonyl group that substitutes the hydrogen atom in the alkoxy group include the same groups as the groups for the unsubstituted alkoxycarbonyl group represented by R¹¹ to R¹⁸ in Formula (1).

Examples of the aryloxycarbonyl group that substitutes the hydrogen atom in the alkoxy group include the same groups as the groups for the unsubstituted aryloxycarbonyl group represented by R¹¹ to R¹⁸ in Formula (1).

Examples of the aralkyl group represented by R¹¹ to R¹⁸ in Formula (1) include a substituted or unsubstituted aralkyl group.

As the unsubstituted aralkyl group represented by R¹¹ to R¹⁸ in Formula (1), for example, an aralkyl group having 7 or more and 30 or less carbon atoms is preferable, an aralkyl group having 7 or more and 16 or less carbon atoms is more preferable, and an aralkyl group having 7 or more and 12 or less carbon atoms is still more preferable.

Examples of the unsubstituted aralkyl group having 7 or more and 30 or less carbon atoms include a benzyl group, a phenylethyl group, a phenylpropyl group, a 4-phenylbutyl group, a phenylpentyl group, a phenylhexyl group, a phenylheptyl group, a phenyloctyl group, a phenylnonyl group, a naphthylmethyl group, a naphthylethyl group, an anthracenylmethyl group, and a phenyl-cyclopentylmethyl group.

Examples of the substituent in the aralkyl group include an alkoxy group, an alkoxycarbonyl group, an aryloxycarbonyl group, and a halogen atom (such as a fluorine atom, a bromine atom, and an iodine atom).

Examples of the alkoxy group that substitutes the hydrogen atom in the aralkyl group include the same groups as the groups for the unsubstituted alkoxy group represented by R¹¹ to R¹⁸ in Formula (1).

Examples of the alkoxycarbonyl group that substitutes the hydrogen atom in the aralkyl group include the same groups as the groups for the unsubstituted alkoxycarbonyl group represented by R¹¹ to R¹⁸ in Formula (1).

Examples of the aryloxycarbonyl group that substitutes the hydrogen atom in the aralkyl group include the same groups as the groups for the unsubstituted aryloxycarbonyl group represented by R¹¹ to R¹⁸ in Formula (1).

Examples of the aryl group represented by R¹¹ to R¹⁸ in Formula (1) include a substituted or unsubstituted aryl group.

As the unsubstituted aryl group represented by R¹¹ to R¹⁸ in Formula (1), for example, an aryl group having 6 or more and 30 or less carbon atoms is preferable, an aryl group having 6 or more and 14 or less carbon atoms is more preferable, and an aryl group having 6 or more and 10 or less carbon atoms is still more preferable.

Examples of the aryl group having 6 or more and 30 or less carbon atoms include a phenyl group, a biphenyl group, a 1-naphthyl group, a 2-naphthyl group, a 9-anthryl group, a 9-phenanthryl group, a 1-pyrenyl group, a 5-naphthacenyl group, a 1-indenyl group, a 2-azulenyl group, a 9-fluorenyl group, a biphenylenyl group, an indacenyl group, a fluoranthenyl group, an acenaphthylenyl group, an aceanthrylenyl group, a phenalenyl group, a fluorenyl group, an anthryl group, a bianthracenyl group, a teranthracenyl group, a quarteranthracenyl group, an anthraquinolyl group, a phenanthryl group, a triphenylenyl group, a pyrenyl group, a chrysenyl group, a naphthacenyl group, a preadenyl group, a picenyl group, a perylenyl group, a pentaphenyl group, a pentacenyl group, a tetraphenylenyl group, a hexaphenyl group, a hexacenyl group, a rubisenyl group, and a coronenyl group. Among the above, for example, a phenyl group is preferable.

Examples of the substituent in the aryl group include an alkyl group, an alkoxy group, an alkoxycarbonyl group, an aryloxycarbonyl group, and a halogen atom (such as a fluorine atom, a bromine atom, and an iodine atom).

Examples of the alkyl group that substitutes the hydrogen atom in the aryl group include the same groups as the groups for the unsubstituted alkyl group represented by R¹¹ to R¹⁸ in Formula (1).

Examples of the alkoxy group that substitutes the hydrogen atom in the aryl group include the same groups as the groups for the unsubstituted alkoxy group represented by R¹¹ to R¹⁸ in Formula (1).

Examples of the alkoxycarbonyl group that substitutes the hydrogen atom in the aryl group include the same groups as the groups for the unsubstituted alkoxycarbonyl group represented by R¹¹ to R¹⁸ in Formula (1).

Examples of the aryloxycarbonyl group that substitutes the hydrogen atom in the aryl group include the same groups as the groups for the unsubstituted aryloxycarbonyl group represented by R¹¹ to R¹⁸ in Formula (1).

Examples of the aryloxy group (—O—Ar; Ar represent an aryl group) represented by R¹¹ to R¹⁸ in Formula (1) include a substituted or unsubstituted aryloxy group.

As the unsubstituted aryloxy group represented by R¹¹ to R¹⁸ in Formula (1), for example, an aryloxy group having 6 or more and 30 or less carbon atoms is preferable, an aryloxy group having 6 or more and 14 or less carbon atoms is more preferable, and an aryloxy group having 6 or more and 10 or less carbon atoms is still more preferable.

Examples of the aryloxy group having 6 or more and 30 or less carbon atoms include a phenyloxy group (phenoxy group), a biphenyloxy group, a 1-naphthyloxy group, a 2-naphthyloxy group, a 9-anthryloxy group, a 9-phenanthryloxy group, a 1-pyrenyloxy group, a 5-naphthacenyloxy group, a 1-indenyloxy group, a 2-azulenyloxy group, a 9-fluorenyloxy group, a biphenylenyloxy group, an indacenyloxy group, a fluoranthenyloxy group, an acenaphthylenyloxy group, an aceanthryleneyloxy group, a phenalenyloxy group, a fluorenyloxy group, an anthryloxy group, a bianthracenyloxy group, a teranthracenyloxy group, a quarteranthracenyloxy group, an anthraquinolyloxy group, a phenanthryloxy group, a triphenylenyloxy group, a pyrenyloxy group, a chrysenyloxy group, a naphthacenyloxy group, a preadenyloxy group, a picenyloxy group, a perylenyloxy group, a pentaphenyloxy group, a pentacenyloxy group, a tetraphenylenyloxy group, a hexaphenyloxy group, a hexacenyloxy group, a rubisenyloxy group, and a coronenyloxy group. Among the above, for example, a phenyloxy group (phenoxy group) is preferable.

Examples of the substituent in the aryloxy group include an alkyl group, an alkoxycarbonyl group, an aryloxycarbonyl group, and a halogen atom (such as a fluorine atom, a bromine atom, and an iodine atom).

Examples of the alkyl group that substitutes the hydrogen atom in the aryloxy group include the same groups as the groups for the unsubstituted alkyl group represented by R¹¹ to R¹⁸ in Formula (1).

Examples of the alkoxycarbonyl group that substitutes the hydrogen atom in the aryloxy group include the same groups as the groups for the unsubstituted alkoxycarbonyl group represented by R¹¹ to R¹⁸ in Formula (1).

Examples of the aryloxycarbonyl group that substitutes the hydrogen atom in the aryloxy group include the same groups as the groups for the unsubstituted aryloxycarbonyl group represented by R¹¹ to R¹⁸ in Formula (1).

Examples of the alkoxycarbonyl group (—CO—OR; R represent an alkyl group) represented by R¹¹ to R¹⁸ in Formula (1) include a substituted or unsubstituted alkoxycarbonyl group.

The number of carbon atoms in an alkyl chain of the unsubstituted alkoxycarbonyl group represented by R¹¹ to R¹⁸ in Formula (1) is, for example, preferably 1 or more and 20 or less, more preferably 1 or more and 15 or less, and still more preferably 1 or more and 10 or less.

Examples of the alkoxycarbonyl group having 1 or more and 20 or less carbon atoms in the alkyl chain include a methoxycarbonyl group, an ethoxycarbonyl group, a propoxycarbonyl group, an isopropoxycarbonyl group, an n-butoxycarbonyl group, a sec-butoxybutylcarbonyl group, a tert-butoxycarbonyl group, a pentaoxycarbonyl group, a hexaoxycarbonyl group, a heptaoxycarbonyl group, an octaoxycarbonyl group, a nonaoxycarbonyl group, a decaoxycarbonyl group, a dodecaoxycarbonyl group, a tridecaoxycarbonyl group, a tetradecaoxycarbonyl group, a pentadecaoxycarbonyl group, a hexadecaoxycarbonyl group, a heptadecaoxycarbonyl group, an octadecaoxycarbonyl group, a nonadecaoxycarbonyl group, and an icosaoxycarbonyl group.

Examples of the substituent in the alkoxycarbonyl group include an aryl group, a hydroxy group, and a halogen atom (such as a fluorine atom, a bromine atom, and an iodine atom).

Examples of the aryl group that substitutes the hydrogen atom in the alkoxycarbonyl group include the same groups as the groups for the unsubstituted aryl group represented by R¹¹ to R¹⁸ in Formula (1).

Examples of the aryloxycarbonyl group (—CO—OAr; Ar represents an aryl group) represented by R¹¹ to R¹⁸ in Formula (1) include a substituted or unsubstituted aryloxycarbonyl group.

The number of carbon atoms in the aryl group of the unsubstituted aryloxycarbonyl group represented by R¹¹ to R¹⁸ in Formula (1) is, for example, preferably 6 or more and 30 or less, more preferably 6 or more and 14 or less, and still more preferably 6 or more and 10 or less.

Examples of the aryloxycarbonyl group having an aryl group with 6 or more and 30 or less carbon atoms include a phenoxycarbonyl group, a biphenyloxycarbonyl group, a 1-naphthyloxycarbonyl group, a 2-naphthyloxycarbonyl group, a 9-anthryloxycarbonyl group, a 9-phenanthryloxycarbonyl group, a 1-pyrenyloxycarbonyl group, a 5-naphthacenyloxycarbonyl group, a 1-indenyloxycarbonyl group, a 2-azulenyloxycarbonyl group, a 9-fluorenyloxycarbonyl group, a biphenylenyloxycarbonyl group, an indacenyloxycarbonyl group, a fluoranthenyloxycarbonyl group, an acenaphthylenyloxycarbonyl group, an aceanthryleneyloxycarbonyl group, a phenalenyloxycarbonyl group, a fluorenyloxycarbonyl group, an anthryloxycarbonyl group, a bianthracenyloxycarbonyl group, a teranthracenyloxycarbonyl group, a quarteranthracenyloxycarbonyl group, an anthraquinolyloxycarbonyl group, a phenanthryloxycarbonyl group, a triphenylenyloxycarbonyl group, a pyrenyloxycarbonyl group, a chrysenyloxycarbonyl group, a naphthacenyloxycarbonyl group, a preadenyloxycarbonyl group, a picenyloxycarbonyl group, a perylenyloxycarbonyl group, a pentaphenyloxycarbonyl group, a pentacenyloxycarbonyl group, a tetraphenylenyloxycarbonyl group, a hexaphenyloxycarbonyl group, a hexacenyloxycarbonyl group, a rubisenyloxycarbonyl group, and a coronenyloxycarbonyl group. Among the above, for example, a phenoxycarbonyl group is preferable.

Examples of the substituent in the aryloxycarbonyl group include an alkyl group, a hydroxy group, and a halogen atom (such as a fluorine atom, a bromine atom, and an iodine atom).

Examples of the alkyl group that substitutes the hydrogen atom in the aryloxycarbonyl group include the same groups as the groups for the unsubstituted alkyl group represented by R¹¹ to R¹⁸ in Formula (1).

Examples of the alkoxycarbonylalkyl group (—(CₙH₂ₙ)—CO—OR; R represents an alkyl group, and n represents an integer of 1 or more) represented by R¹¹ to R¹⁸ in Formula (1) include a substituted or unsubstituted alkoxycarbonylalkyl group.

Examples of the alkoxycarbonyl group (—CO—OR) in the unsubstituted alkoxycarbonylalkyl group represented by R¹¹ to R¹⁸ in Formula (1) include the same groups as the groups for the alkoxycarbonyl group represented by R¹¹ to R¹⁸ in Formula (1).

Examples of the alkylene chain (—CₙH₂ₙ—) in the unsubstituted alkoxycarbonylalkyl group represented by R¹¹ to R¹⁸ in Formula (1) include a linear alkylene chain having 1 or more and 20 or less carbon atoms (for example, preferably having 1 or more and 10 or less carbon atoms and more preferably having 1 or more and 6 or less carbon atoms), a branched alkylene chain having 3 or more and 20 or less carbon atoms (for example, preferably having 3 or more and 10 or less carbon atoms), and a cyclic alkylene chain having 3 or more and 20 or less carbon atoms (for example, preferably having 3 or more and 10 or less carbon atoms).

Examples of the linear alkylene chain having 1 or more and 20 or less carbon atoms include a methylene group, an ethylene group, an n-propylene group, an n-butylene group, an n-pentylene group, an n-hexylene group, an n-heptylene group, an n-octylene group, an n-nonylene group, an n-decylene group, an n-undecylene group, an n-dodecylene group, a tridecylene group, an n-tetradecylene group, an n-pentadecylene group, an n-heptadecylene group, an n-octadecylene group, an n-nonadecylene group, and an n-icosylene group. Examples of the branched alkylene chain having 3 or more and 20 or less carbon atoms include an isopropylene group, an isobutylene group, a sec-butylene group, a tert-butylene group, an isopentylene group, a neopentylene group, a tert-pentylene group, an isohexylene group, a sec-hexylene group, a tert-hexylene group, an isoheptylene group, a sec-heptylene group, a tert-heptylene group, an isooctylene group, a sec-octylene group, a tert-octylene group, an isononylene group, a sec-nonylene group, a tert-nonylene group, an isodecylene group, a sec-decylene group, a tert-decylene group, an isododecylene group, a sec-dodecylene group, a tert-dodecylene group, a tert-tetradecylene group, and a tert-pentadecylene group.

Examples of the cyclic alkylene chain having 3 or more and 20 or less carbon atoms include a cyclopropylene group, a cyclobutylene group, a cyclopentylene group, a cyclohexylene group, a cycloheptyrene group, a cyclooctylene group, a cyclononylene group, and a cyclodecylene group.

Examples of the substituent in the alkoxycarbonylalkyl group include an aryl group, a hydroxy group, and a halogen atom (such as a fluorine atom, a bromine atom, and an iodine atom).

Examples of the aryl group that substitutes the hydrogen atom in the alkoxycarbonylalkyl group include the same groups as the groups for the unsubstituted aryl group represented by R¹¹ to R¹⁸ in Formula (1).

Examples of the aryloxycarbonylalkyl group (—(CₙH₂ₙ)—CO—OAr; Ar represents an aryl group, and n represents an integer of 1 or more) represented by R¹¹ to R¹⁸ in Formula (1) include a substituted or unsubstituted aryloxycarbonylalkyl group.

Examples of the aryloxycarbonyl group (—CO—OAr; Ar represents an aryl group) in the unsubstituted aryloxycarbonylalkyl group represented by R¹¹ to R¹⁸ in Formula (1) include the same groups as the groups for the aryloxycarbonyl group represented by R¹¹ to R¹⁸ in Formula (1).

Examples of the alkylene chain (—CₙH₂ₙ—) in the unsubstituted aryloxycarbonylalkyl group represented by R¹¹ to R¹⁸ in Formula (1) include the same groups as the groups for the alkylene chain in the alkoxycarbonylalkyl group represented by R¹¹ to R¹⁸ in Formula (1).

Examples of the substituent in the aryloxycarbonylalkyl group include an alkyl group, a hydroxy group, and a halogen atom (such as a fluorine atom, a bromine atom, and an iodine atom).

Examples of the alkyl group that substitutes the hydrogen atom in the aryloxycarbonylalkyl group include the same groups as the groups for the unsubstituted alkyl group represented by R¹¹ to R¹⁸ in Formula (1).

Examples of the halogen atom represented by R¹¹ to R¹⁸ in Formula (1) include a fluorine atom, a chlorine atom, a bromine atom, and an iodine atom.

Examples of a ring structure to be formed by linking R¹¹ and R¹², R¹² and R¹³, R¹³ and R¹⁴, R¹⁵ and R¹⁶, R¹⁶ and R¹⁷, or R¹⁷ and R¹⁸ in Formula (1) to each other include a benzene ring and a fused ring having 10 or more and 18 or less carbon atoms (such as a naphthalene ring, an anthracene ring, a phenanthrene ring, a chrysene ring (benzo[a]phenanthrene ring), a tetracene ring, a tetraphene ring (benzo[a]anthracene ring), and a triphenylene ring). Among the above, for example, a benzene ring is preferable as the ring structure to be formed.

Examples of the alkyl group represented by R²¹ to R²⁸ in Formula (2) include the same groups as the groups for the alkyl group represented by R¹¹ to R¹⁸ in Formula (1).

Examples of the alkoxy groups represented by R²¹ to R²⁸ in Formula (2) include the same groups as the groups for the alkoxy group represented by R¹¹ to R¹⁸ in Formula (1).

Examples of the aralkyl group represented by R²¹ to R²⁸ in Formula (2) include the same groups as the groups for the aralkyl group represented by R¹¹ to R¹⁸ in Formula (1).

Examples of the aryl group represented by R²¹ to R²⁸ in Formula (2) include the same groups as the groups for the aryl group represented by R¹¹ to R¹⁸ in Formula (1).

Examples of the aryloxy group represented by R²¹ to R²⁸ in Formula (2) include the same groups as the groups for the aryloxy group represented by R¹¹ to R¹⁸ in Formula (1).

Examples of the alkoxycarbonyl group represented by R²¹ to R²⁸ in Formula (2) include the same groups as the groups for the alkoxycarbonyl group represented by R¹¹ to R¹⁸ in Formula (1).

Examples of the aryloxycarbonyl group represented by R²¹ to R²⁸ in Formula (2) include the same groups as the groups for the aryloxycarbonyl group represented by R¹¹ to R¹⁸ in Formula (1).

Examples of the alkoxycarbonylalkyl group represented by R²¹ to R²⁸ in Formula (2) include the same groups as the groups for the alkoxycarbonylalkyl group represented by R¹¹ to R¹⁸ in Formula (1).

Examples of the aryloxycarbonylalkyl group represented by R²¹ to R²⁸ in Formula (2) include the same groups as the groups for the aryloxycarbonylalkyl group represented by R¹¹ to R¹⁸ in Formula (1).

Examples of the halogen atom represented by R²¹ to R²⁸ in Formula (2) include the same atoms as the atoms for the halogen atom represented by R¹¹ to R¹⁸ in Formula (1).

Examples of a ring structure to be formed by linking R²¹ and R²², R²² and R²³, R²³ and R²⁴, R²⁵ and R²⁶, R²⁶ and R²⁷, or R²⁷ and R²⁸ in Formula (2) to each other include a benzene ring and a fused ring having 10 or more and 18 or less carbon atoms (such as a naphthalene ring, an anthracene ring, a phenanthrene ring, a chrysene ring (benzo[a] phenanthrene ring), a tetracene ring, a tetraphene ring (benzo[a]anthracene ring), and a triphenylene ring). Among the above, for example, a benzene ring is preferable as the ring structure to be formed.

For example, it is preferable that R¹¹, R¹², R¹³, R¹⁴, R¹⁵, R¹⁶, R¹⁷, and R¹⁸ in Formula (1) are each independently a hydrogen atom, an alkyl group, an alkoxycarbonyl group, an aryloxycarbonyl group, an alkoxycarbonylalkyl group, or an aryloxycarbonylalkyl group.

For example, it is more preferable that R¹¹, R¹², R¹³, R¹⁴, R¹⁵, R¹⁶, R¹⁷, and R¹⁸ in Formula (1) are each independently a hydrogen atom or an alkyl group. Here, the form of the alkyl group is as described above.

For example, it is particularly preferable that R¹¹, R¹², R¹³, R¹⁴, R¹⁵, R¹⁶, R¹⁷, and R¹⁸ in Formula (1) are hydrogen atoms.

For example, it is preferable that R²¹, R²², R²³, R²⁴, R²⁵, R²⁶, R²⁷, and R²⁸ in Formula (2) are each independently a hydrogen atom, an alkyl group, an alkoxycarbonyl group, an aryloxycarbonyl group, an alkoxycarbonylalkyl group, or an aryloxycarbonylalkyl group.

For example, it is more preferable that R²¹, R²², R²³, R²⁴, R²⁵, R²⁶, R²⁷, and R²⁸ in Formula (2) are each independently a hydrogen atom or an alkyl group. Here, the form of the alkyl group is as described above.

For example, it is particularly preferable that R²¹, R²², R²³, R²⁴, R²⁵, R²⁶, R²⁷, and R²⁸ in Formula (2) are hydrogen atoms.

Specific examples of the perinone compound (1) and the perinone compound (2) are shown below, but the present exemplary embodiment is not limited thereto. In the following structural formulae, Ph represents a phenyl group.

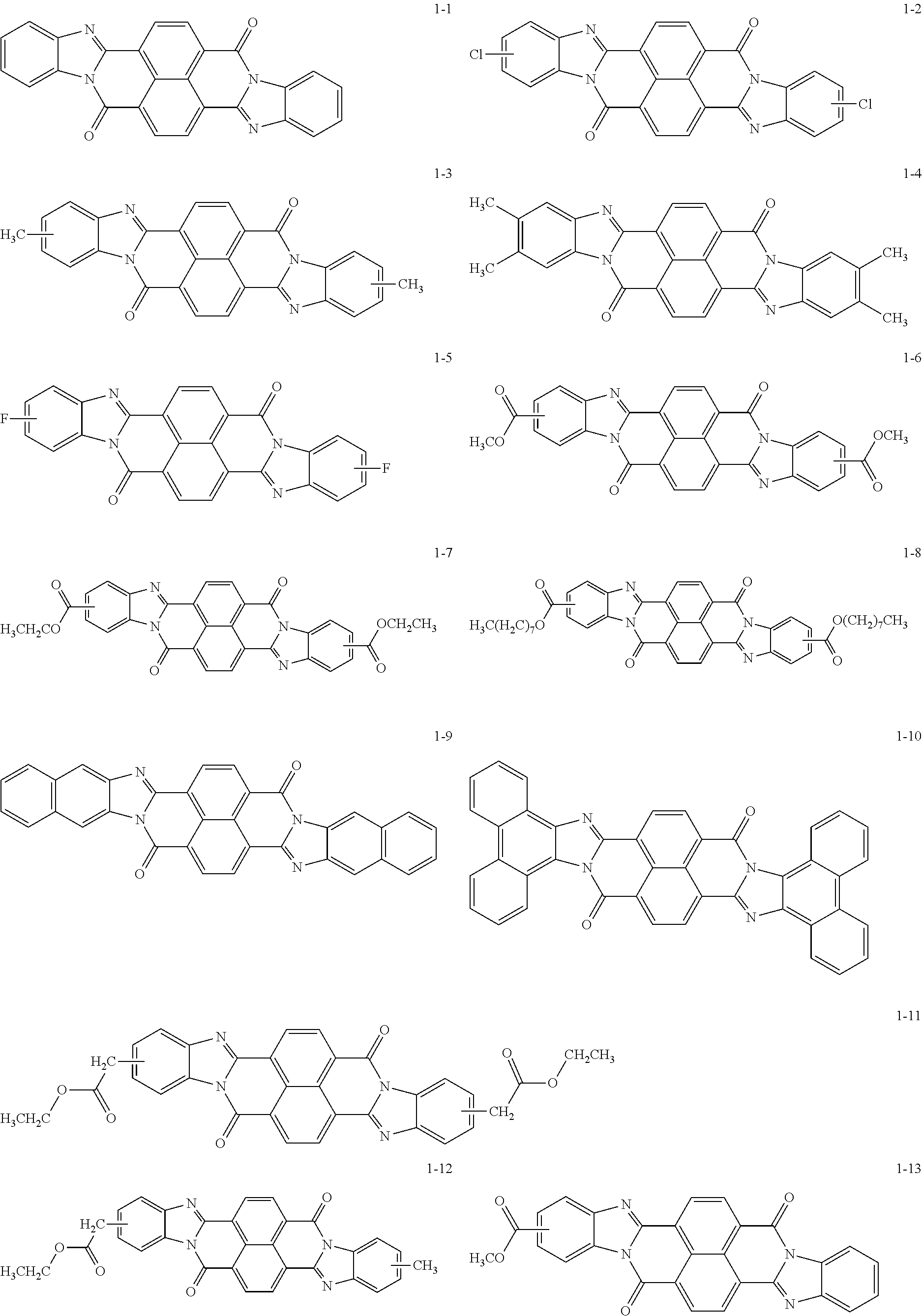

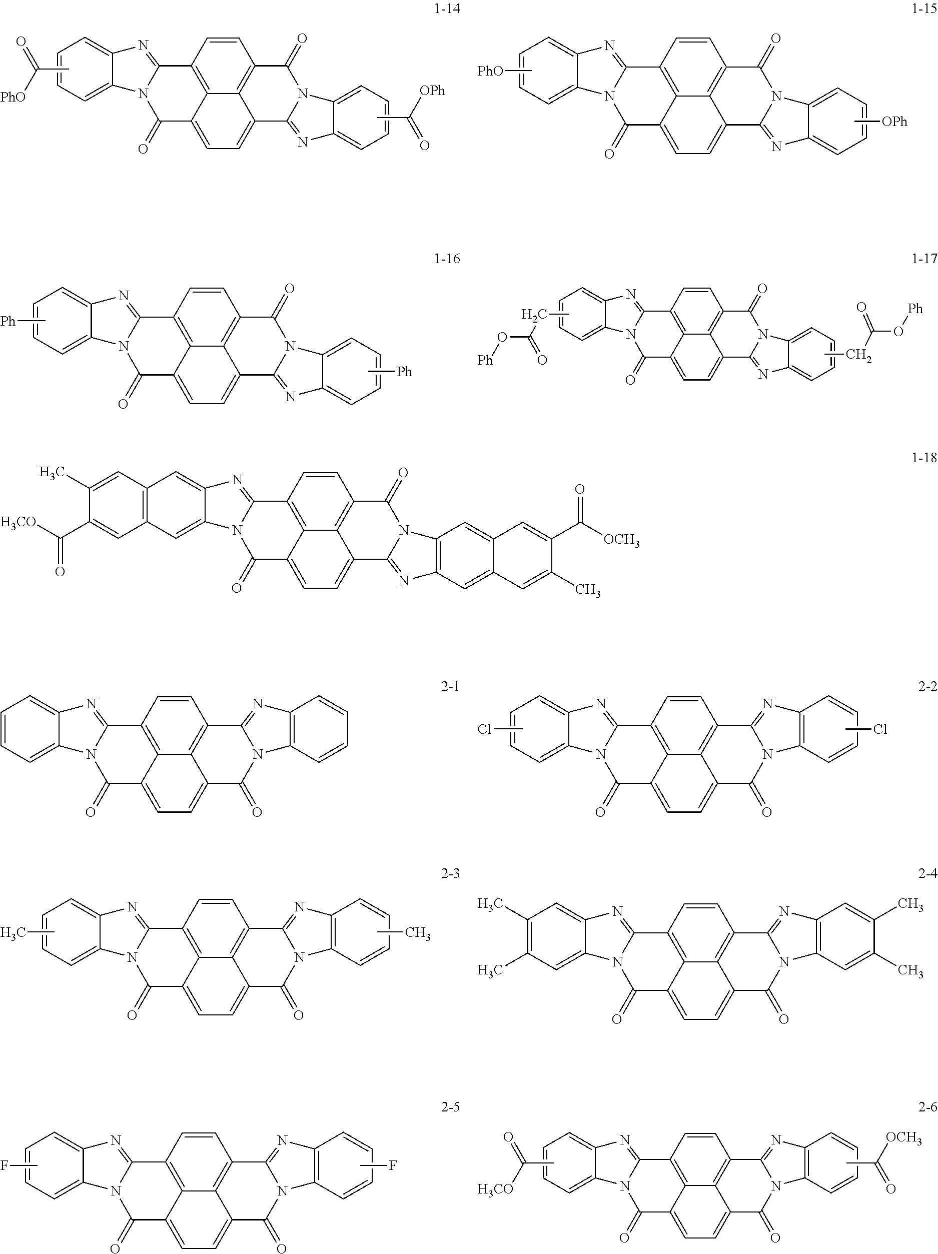

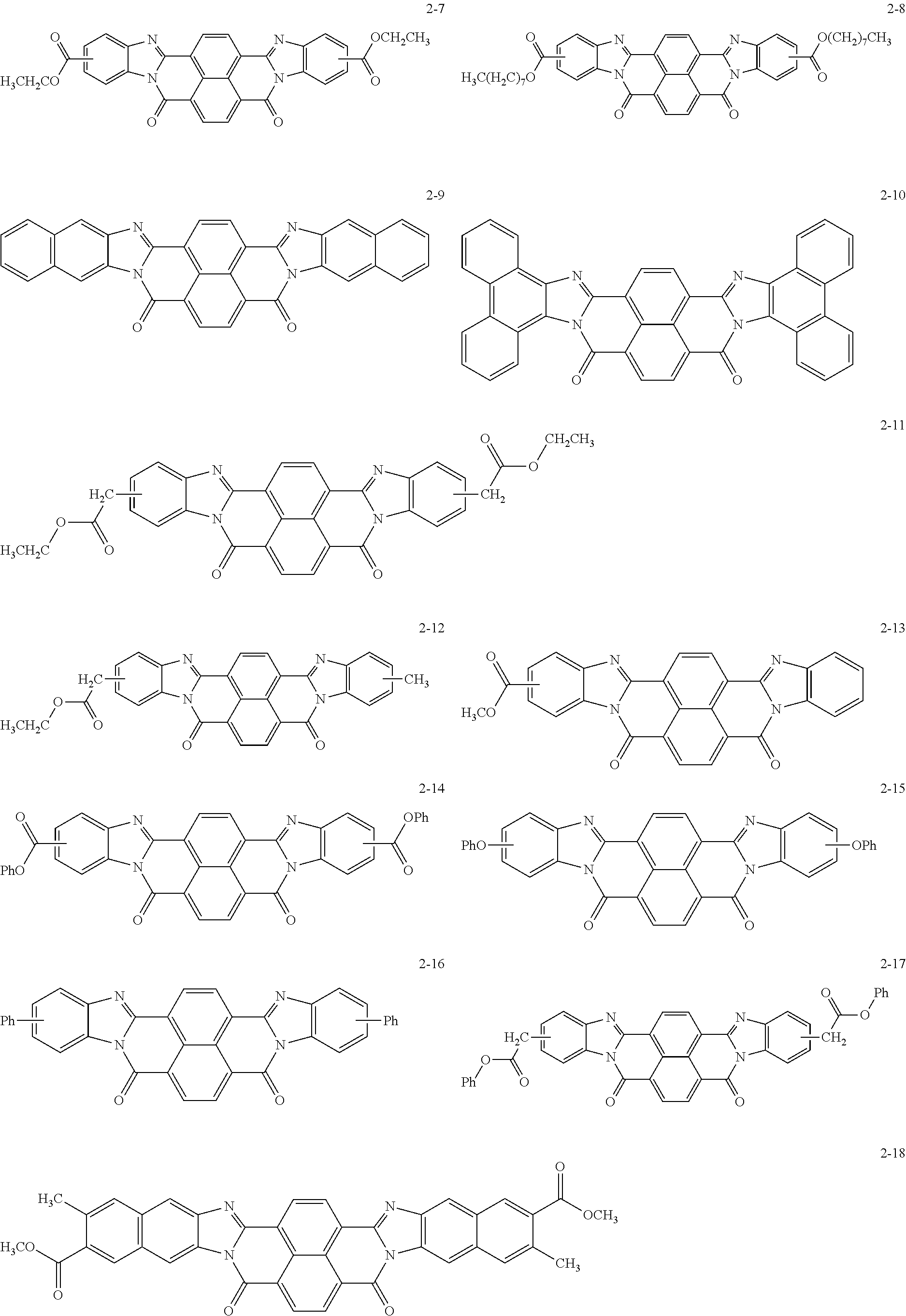

The perinone compounds (2-1) to (2-18) each have an isomer relationship (relationship between a cis-form and a trans-form) with the perinone compounds (1-1) to (1-18). A mixture of isomers tends to be obtained by a synthetic method using the perinone compounds. One of the isomers can be purified from the mixture by a known purification method.

As an example of the exemplary embodiment, the undercoat layer may contain both the perinone compound (1) and the perinone compound (2). Regardless of whether the perinone compound (1) and the perinone compound (2) have an isomer relationship or not, a mass ratio of the perinone compound (1) and the perinone compound (2) (perinone compound (1): perinone compound (2)) is, for example, preferably 3:97 to 97:3, more preferably 5:95 to 95:5, and still more preferably 10:90 to 90:10.

### Perylenetetracarboxylic Acid Dianhydride

The perylenetetracarboxylic acid dianhydride is the compound represented by Formula (3).

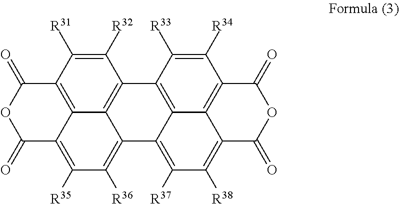

In Formula (3), R³¹, R³², R³³, R³⁴, R³⁵, R³⁶, R³⁷, and R³⁸ each independently represent a hydrogen atom, an alkyl group, an alkoxy group, an aralkyl group, an aryl group, an alkoxycarbonyl group, or a halogen atom.

The compound represented by Formula (3) has excellent electron transport properties and low hole transport properties. Therefore, in a case where the undercoat layer contains the compound represented by Formula (3), the undercoat layer has excellent electron transport properties, the conductive path in the undercoat layer is likely to be secured, and leakage current is further suppressed. In addition, the charge retention property is more excellent because the dark decay is further reduced.

In Formula (3), for example, R³¹, R³², R³³, R³⁴, R³⁵, R³⁶, R³⁷, and R³⁸ each independently preferably represent a hydrogen atom, an alkyl group, or a halogen atom, and more preferably represent a hydrogen atom.

In Formula (3), in a case where R³¹ to R³⁸ are a hydrogen atom, an alkyl group, or a halogen atom (for example, more preferably a hydrogen atom), the undercoat layer has excellent electron transport properties, the conductive path in the undercoat layer is easily secured, and the leakage current is further suppressed. In addition, the charge retention property is more excellent because the dark decay is further reduced.

Examples of the alkyl group represented by R³¹ to R³⁸ in Formula (3) include a substituted or unsubstituted alkyl group.

Examples of the unsubstituted alkyl group represented by R³¹ to R³⁸ in Formula (3) include a linear alkyl group having 1 or more and 20 or less carbon atoms (for example, preferably having 1 or more and 10 or less carbon atoms and more preferably having 1 or more and 6 or less carbon atoms), a branched alkyl group having 3 or more and 20 or less carbon atoms (for example, preferably having 3 or more and 10 or less carbon atoms), and a cyclic alkyl group having 3 or more and 20 or less carbon atoms (for example, preferably having 3 or more and 10 or less carbon atoms).

Examples of the linear alkyl group having 1 or more and 20 or less carbon atoms include a methyl group, an ethyl group, an n-propyl group, an n-butyl group, an n-pentyl group, an n-hexyl group, an n-heptyl group, an n-octyl group, an n-nonyl group, an n-decyl group, an n-undecyl group, an n-dodecyl group, a tridecyl group, an n-tetradecyl group, an n-pentadecyl group, an n-heptadecyl group, an n-octadecyl group, an n-nonadecyl group, and an n-icosyl group.

Specific examples of the branched alkyl group having 3 or more and 20 or less carbon atoms include an isopropyl group, an isobutyl group, a sec-butyl group, a tert-butyl group, an isopentyl group, a neopentyl group, a tert-pentyl group, an isohexyl group, a sec-hexyl group, a tert-hexyl group, an isoheptyl group, a sec-heptyl group, a tert-heptyl group, an isooctyl group, a sec-octyl group, a tert-octyl group, an isononyl group, a sec-nonyl group, a tert-nonyl group, an isodecyl group, a sec-decyl group, a tert-decyl group, an isododecyl group, a sec-dodecyl group, a tert-dodecyl group, a tert-tetradecyl group, and a tert-pentadecyl group.

Examples of the cyclic alkyl group having 3 or more and 20 or less carbon atoms include a cyclopropyl group, a cyclobutyl group, a cyclopentyl group, a cyclohexyl group, a cycloheptyl group, a cyclooctyl group, a cyclononyl group, a cyclodecyl group, and the like, and a polycyclic (for example, bicyclic, tricyclic, spirocyclic, or the like) alkyl group composed of these monocyclic alkyl groups linked to each other.

Among the above, for example, a linear alkyl group such as a methyl group and an ethyl group is preferable as the unsubstituted alkyl group.

Examples of the substituent in the alkyl group include an alkoxy group, a hydroxy group, a carboxy group, a nitro group, and a halogen atom (such as a fluorine atom, a bromine atom, and an iodine atom).

Examples of the alkoxy group that substitutes the hydrogen atom in the alkyl group include the same groups as the groups for the unsubstituted alkoxy group represented by R³¹ to R³⁸ in Formula (3).

Examples of the alkoxy group represented by R³¹ to R³⁸ in Formula (3) include a substituted or unsubstituted alkoxy group.

Examples of the unsubstituted alkoxy group represented by R³¹ to R³⁸ in Formula (3) include a linear, branched, or cyclic alkoxy group having 1 or more and 10 or less carbon atoms (for example, preferably having 1 or more and 6 or less carbon atoms, and more preferably having 1 or more and 4 or less carbon atoms).

Specific examples of the linear alkoxy group include a methoxy group, an ethoxy group, an n-propoxy group, an n-butoxy group, an n-pentyloxy group, an n-hexyloxy group, an n-heptyloxy group, an n-octyloxy group, an n-nonyloxy group, and an n-decyloxy group.

Specific examples of the branched alkoxy group include an isopropoxy group, an isobutoxy group, a sec-butoxy group, a tert-butoxy group, an isopentyloxy group, a neopentyloxy group, a tert-pentyloxy group, an isohexyloxy group, a sec-hexyloxy group, a tert-hexyloxy group, an isoheptyloxy group, a sec-heptyloxy group, a tert-heptyloxy group, an isooctyloxy group, a sec-octyloxy group, a tert-octyloxy group, an isononyloxy group, a sec-nonyloxy group, a tert-nonyloxy group, an isodecyloxy group, a sec-decyloxy group, and a tert-decyloxy group.

Specific examples of the cyclic alkoxy group include a cyclopropoxy group, a cyclobutoxy group, a cyclopentyloxy group, a cyclohexyloxy group, a cycloheptyloxy group, a cyclooctyloxy group, a cyclononyloxy group, and a cyclodecyloxy group.

Among the above, for example, a linear alkoxy group is preferable as the unsubstituted alkoxy group.

Examples of the substituent in the alkoxy group include an aryl group, an alkoxycarbonyl group, an aryloxycarbonyl group, a hydroxyl group, a carboxy group, a nitro group, and a halogen atom (such as a fluorine atom, a bromine atom, and an iodine atom).

Examples of the aryl group that substitutes the hydrogen atom in the alkoxy group include the same groups as the groups for the unsubstituted aryl group represented by R³¹ to R³⁸ in Formula (3).

Examples of the alkoxycarbonyl group that substitutes the hydrogen atom in the alkoxy group include the same groups as the groups for the unsubstituted alkoxycarbonyl group represented by R³¹ to R³⁸ in Formula (3).

Examples of the aryloxycarbonyl group that substitutes the hydrogen atom in the alkoxy group include the same groups as the groups for the unsubstituted aryloxycarbonyl group represented by R³¹ to R³⁸ in Formula (3).

Examples of the aralkyl group represented by R³¹ to R³⁸ in Formula (3) include a substituted or unsubstituted aralkyl group.

As the unsubstituted aralkyl group represented by R³¹ to R³⁸ in Formula (3), for example, an aralkyl group having 7 or more and 30 or less carbon atoms is preferable, an aralkyl group having 7 or more and 16 or less carbon atoms is more preferable, and an aralkyl group having 7 or more and 12 or less carbon atoms is still more preferable.

Examples of the unsubstituted aralkyl group having 7 or more and 30 or less carbon atoms include a benzyl group, a phenylethyl group, a phenylpropyl group, a 4-phenylbutyl group, a phenylpentyl group, a phenylhexyl group, a phenylheptyl group, a phenyloctyl group, a phenylnonyl group, a naphthylmethyl group, a naphthylethyl group, an anthracenylmethyl group, and a phenyl-cyclopentylmethyl group.

Examples of the substituent in the aralkyl group include an alkoxy group, an alkoxycarbonyl group, and a halogen atom (such as a fluorine atom, a bromine atom, and an iodine atom).

Examples of the alkoxy group that substitutes the hydrogen atom in the aralkyl group include the same groups as the groups for the unsubstituted alkoxy group represented by R³¹ to R³⁸ in Formula (3).

Examples of the alkoxycarbonyl group that substitutes the hydrogen atom in the aralkyl group include the same groups as the groups for the unsubstituted alkoxycarbonyl group represented by R³¹ to R³⁸ in Formula (3).

Examples of the aryl group represented by R³¹ to R³⁸ in Formula (3) include a substituted or unsubstituted aryl group.

As the unsubstituted aryl group represented by R³¹ to R³⁸ in Formula (3), for example, an aryl group having 6 or more and 30 or less carbon atoms is preferable, an aryl group having 6 or more and 14 or less carbon atoms is more preferable, and an aryl group having 6 or more and 10 or less carbon atoms is still more preferable.

Examples of the aryl group having 6 or more and 30 or less carbon atoms include a phenyl group, a biphenyl group, a 1-naphthyl group, a 2-naphthyl group, a 9-anthryl group, a 9-phenanthryl group, a 1-pyrenyl group, a 5-naphthacenyl group, a 1-indenyl group, a 2-azulenyl group, a 9-fluorenyl group, a biphenylenyl group, an indacenyl group, a fluoranthenyl group, an acenaphthylenyl group, an aceanthrylenyl group, a phenalenyl group, a fluorenyl group, an anthryl group, a bianthracenyl group, a teranthracenyl group, a quarteranthracenyl group, an anthraquinolyl group, a phenanthryl group, a triphenylenyl group, a pyrenyl group, a chrysenyl group, a naphthacenyl group, a preadenyl group, a picenyl group, a perylenyl group, a pentaphenyl group, a pentacenyl group, a tetraphenylenyl group, a hexaphenyl group, a hexacenyl group, a rubisenyl group, and a coronenyl group. Among the above, for example, a phenyl group is preferable.

Examples of the substituent in the aryl group include an alkyl group, an alkoxy group, an alkoxycarbonyl group, an aryloxycarbonyl group, and a halogen atom (such as a fluorine atom, a bromine atom, and an iodine atom).

Examples of the alkyl group that substitutes the hydrogen atom in the aryl group include the same groups as the groups for the unsubstituted alkyl group represented by R³¹ to R³⁸ in Formula (3).

Examples of the alkoxy group that substitutes the hydrogen atom in the aryl group include the same groups as the groups for the unsubstituted alkoxy group represented by R³¹ to R³⁸ in Formula (3).

Examples of the alkoxycarbonyl group that substitutes the hydrogen atom in the aryl group include the same groups as the groups for the unsubstituted alkoxycarbonyl group represented by R³¹ to R³⁸ in Formula (3).

Examples of the alkoxycarbonyl group represented by R³¹ to R³⁸ in Formula (3) include a substituted or unsubstituted alkoxycarbonyl group.

The number of carbon atoms in an alkyl chain of the unsubstituted alkoxycarbonyl group represented by R³¹ to R³⁸ in Formula (3) is, for example, preferably 1 or more and 20 or less, more preferably 1 or more and 15 or less, and still more preferably 1 or more and 10 or less.

Examples of the alkoxycarbonyl group having 1 or more and 20 or less carbon atoms in the alkyl chain include a methoxycarbonyl group, an ethoxycarbonyl group, a propoxycarbonyl group, an isopropoxycarbonyl group, an n-butoxycarbonyl group, a sec-butoxybutylcarbonyl group, a tert-butoxycarbonyl group, a pentaoxycarbonyl group, a hexaoxycarbonyl group, a heptaoxycarbonyl group, an octaoxycarbonyl group, a nonaoxycarbonyl group, a decaoxycarbonyl group, a dodecaoxycarbonyl group, a tridecaoxycarbonyl group, a tetradecaoxycarbonyl group, a pentadecaoxycarbonyl group, a hexadecaoxycarbonyl group, a heptadecaoxycarbonyl group, an octadecaoxycarbonyl group, a nonadecaoxycarbonyl group, and an icosaoxycarbonyl group.

Examples of the substituent in the alkoxycarbonyl group include an aryl group, a hydroxy group, and a halogen atom (such as a fluorine atom, a bromine atom, and an iodine atom).

Examples of the aryl group that substitutes the hydrogen atom in the alkoxycarbonyl group include the same groups as the groups for the unsubstituted aryl group represented by R³¹ to R³⁸ in Formula (3).

Examples of the halogen atom represented by R³¹ to R³⁸ in Formula (3) include a fluorine atom, a chlorine atom, a bromine atom, and an iodine atom.

Exemplary compounds of the compound represented by Formula (3) are shown below, but the present exemplary embodiment is not limited thereto. The following exemplary compound numbers will be referred to as exemplary compounds (3-number) below.

| Exemplary | Exemplary compound of compound |
|---|---|
| number | represented by Formula (3) |
| 3-1 | 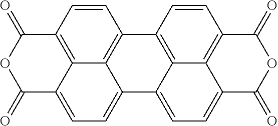 [SMILES: O=C1OC(=O)c2ccc3c4ccc5c6c(ccc(c7ccc1c2c73)c64)C(=O)OC5=O] |
| 3-2 | 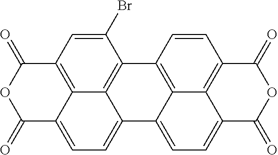 [SMILES: O=C1OC(=O)c2ccc3c4c(Br)cc5c6c(ccc(c7ccc1c2c73)c64)C(=O)OC5=O] |
| 3-3 | 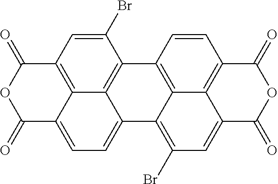 [SMILES: O=C1OC(=O)c2cc(Br)c3c4ccc5c6c(cc(Br)c(c7ccc1c2c73)c64)C(=O)OC5=O] |
| 3-4 | 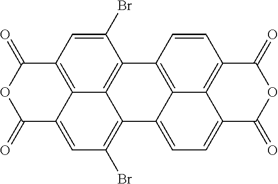 [SMILES: O=C1OC(=O)c2ccc3c4c(Br)cc5c6c(cc(Br)c(c7ccc1c2c73)c64)C(=O)OC5=O] |
| 3-5 | 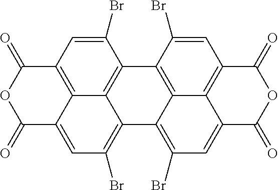 [SMILES: O=C1OC(=O)c2cc(Br)c3c4c(Br)cc5c6c(cc(Br)c(c7c(Br)cc1c2c73)c64)C(=O)OC5=O] |
| 3-6 | 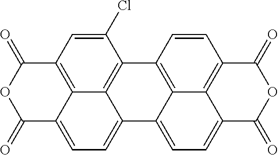 [SMILES: O=C1OC(=O)c2ccc3c4c(Cl)cc5c6c(ccc(c7ccc1c2c73)c64)C(=O)OC5=O] |
| 3-7 | 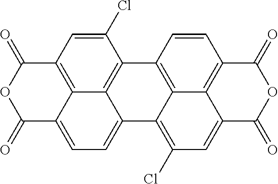 [SMILES: O=C1OC(=O)c2cc(Cl)c3c4ccc5c6c(cc(Cl)c(c7ccc1c2c73)c64)C(=O)OC5=O] |
| 3-8 | 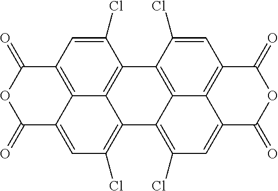 [SMILES: O=C1OC(=O)c2cc(Cl)c3c4c(Cl)cc5c6c(cc(Cl)c(c7c(Cl)cc1c2c73)c64)C(=O)OC5=O] |
| 3-9 | 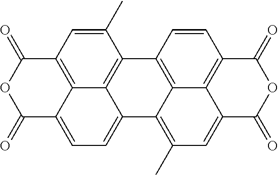 [SMILES: Cc1cc2c3c(ccc4c5c(C)cc6c7c(ccc(c1c34)c75)C(=O)OC6=O)C(=O)OC2=O] |
| 3-10 | 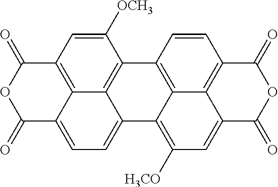 [SMILES: COc1cc2c3c(ccc4c5c(OC)cc6c7c(ccc(c1c34)c75)C(=O)OC6=O)C(=O)OC2=O] |
| 3-11 | 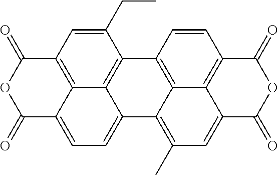 [SMILES: CCc1cc2c3c(ccc4c5c(C)cc6c7c(ccc(c1c34)c75)C(=O)OC6=O)C(=O)OC2=O] |
| 3-12 | 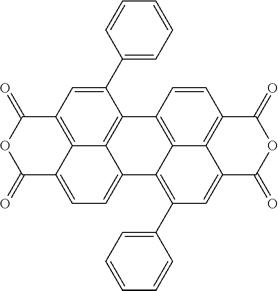 [SMILES: O=C1OC(=O)c2cc(-c3ccccc3)c3c4ccc5c6c(cc(-c7ccccc7)c(c7ccc1c2c73)c64)C(=O)OC5=O] |
| 3-13 | 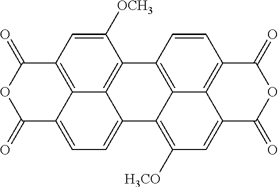 [SMILES: COc1cc2c3c(ccc4c5c(OC)cc6c7c(ccc(c1c34)c75)C(=O)OC6=O)C(=O)OC2=O] |
| 3-14 | 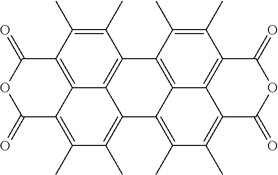 [SMILES: Cc1c2c3c(c(C)c(C)c4c5c(C)c(C)c6c7c(c(C)c(C)c(c(c1C)c34)c75)C(=O)OC6=O)C(=O)OC2=O] |
| 3-15 | 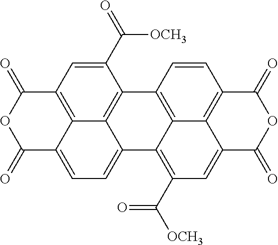 [SMILES: COC(=O)c1cc2c3c(ccc4c5c(C(=O)OC)cc6c7c(ccc(c1c34)c75)C(=O)OC6=O)C(=O)OC2=O] |
| 3-16 | 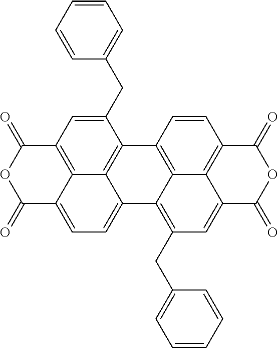 [SMILES: O=C1OC(=O)c2cc(Cc3ccccc3)c3c4ccc5c6c(cc(Cc7ccccc7)c(c7ccc1c2c73)c64)C(=O)OC5=O] |
| 3-17 | 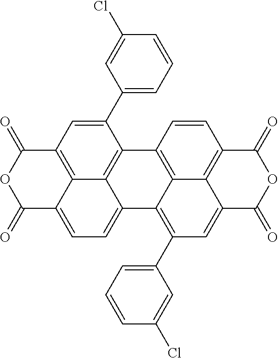 [SMILES: O=C1OC(=O)c2cc(-c3cccc(Cl)c3)c3c4ccc5c6c(cc(-c7cccc(Cl)c7)c(c7ccc1c2c73)c64)C(=O)OC5=O] |
| 3-18 | 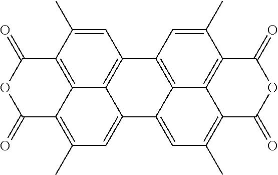 [SMILES: Cc1cc2c3cc(C)c4c5c(c(C)cc(c6cc(C)c7c(c1C(=O)OC7=O)c26)c53)C(=O)OC4=O] |

An average primary particle size of the electron transport material is, for example, preferably 20 nm or more and 1,000 nm or less, more preferably 30 nm or more and 800 nm or less, and still more preferably 50 nm or more and 700 nm or less.

In a case where the average primary particle size of the electron transport material is 20 nm or more, aggregation of the electron transport material in the undercoat layer is suppressed, and the electron transport material is likely to be present with high dispersibility. As a result, the electron transport properties are more excellent, and the hole transport properties are likely to be further lowered. As a result, the electron transport properties are more excellent, the hole transport properties are likely to be further lowered, and the charge retention property is more excellent. In addition, the conductive path is more excellent, and the accumulation of the residual potential and the suppression of the leakage current are more excellent.

In a case where the average primary particle size of the electron transport material is 1,000 nm or less, the electron transport material is likely to be localized in the undercoat layer and is likely to be present with high dispersibility. As a result, the electron transport properties are more excellent, the hole transport properties are likely to be further lowered, and the charge retention property is more excellent. In addition, the conductive path is more excellent, and the accumulation of the residual potential and the suppression of the leakage current are more excellent.

The average primary particle size of the electron transport material is determined as follows.

The electron transport material is specified by observing the laminated cross section of the undercoat layer of the photoreceptor in the thickness direction at a magnification of 100,000 times using a scanning electron microscope (SEM). Particle diameters of any 10 particles in the obtained SEM image, present as the primary particles in the electron transport material, are determined. An arithmetic average value of the obtained particle diameters is defined as the average primary particle size of the electron transport material.

In the compound represented by Formula (3), an aspect ratio is, for example, preferably 1.0 or more and 5.0 or less, more preferably 1.1 or more and 3 or less, and still more preferably 1.2 or more and 2.5 or less.

In a case where the aspect ratio of the compound represented by Formula (3) is 2.5 or less, the electron transport material is likely to be present in the undercoat layer with high dispersibility, and thus the electron transport properties are more excellent and the hole transport properties are likely to be further lowered. In a case where the aspect ratio of the compound represented by Formula (3) is 1.0 or more and 5 or less, the electron transport material is likely to be present in the undercoat layer with high dispersibility, and thus the electron transport properties are more excellent and the charge retention property is likely to be maintained.

The aspect ratio of the compound represented by Formula (3) means a ratio (length of major axis/length of minor axis) of a length of a major axis of the electron transport material to a length of a minor axis of the electron transport material.

The above-described length of the electron transport material in the major axis direction denotes the distance of the longest straight line formed by connecting one end portion and the other end portion of the electron transport material in the major axis direction. The above-described length of the electron transport material in the minor axis direction denotes the distance of the longest straight line formed by connecting one end portion and the other end portion of the electron transport material in a direction orthogonal to the major axis.

The compound represented by Formula (3) is specified by removing the photosensitive layer (and the protective layer as necessary) from the photoreceptor and observing the undercoat layer with a field emission scanning electron microscope (JSM-6700F, manufactured by JEOL Ltd.) at a magnification of 3,000 to 100,000 times. The length of the major axis and the length of the minor axis are measured at any ten points of the electron transport material on the obtained micrograph, and each of aspect ratios (length of major axis/length of minor axis) is determined. The arithmetic average value of the obtained aspect ratios is defined as the aspect ratio of the compound represented by Formula (3).

A method of adjusting the average primary particle size and the aspect ratio of the compound represented by Formula (3) to be in the above-described ranges is not particularly limited, and examples thereof include a method of pulverizing the electron transport material using a ball mill, a bead mill, a mortar, a sand mill, a kneader, an attritor or the like and a method of precipitating microcrystals by dissolving the electron transport material in fluoroacetic acid, sulfuric acid, or the like and bringing the mixture into contact with water or a poor solvent.

The undercoat layer may further contain other electron transport materials in addition to the compounds represented by Formulae (1) to (3) within a range in which the effect of the present disclosure is exhibited.

A proportion of the total amount of the compound represented by Formulae (1) to (3) to the total amount of the electron transport material in the undercoat layer is, for example, preferably 80% by mass or more and 100% by mass or less, more preferably 90% by mass or more and 100% by mass or less, and still more preferably 95% by mass or more and 100% by mass or less.

The total amount of the charge transport material containing the compound represented by Formulae (1) to (3) in the entire undercoat layer may be less than 70% by mass with respect to the total solid content of the specific undercoat layer. Here, the entire undercoat layer refers to a laminate of the first undercoat layer and the second undercoat layer in the first exemplary embodiment, and the specific undercoat layer in the second exemplary embodiment.

In the related art, from the viewpoint of charge retention property, the content of the electron transport material is, for example, preferably 70% by mass or more with respect to the total solid content of the undercoat layer. On the other hand, in the present exemplary embodiment, since the charge transport material contains at least one of the compounds represented by Formulae (1) to (3), having low hole transport properties in addition to excellent electron transport properties, even in a case where the total amount of the electron transport material is less than 70% by mass, the suppression of the leakage current, the suppression of the accumulation of the residual potential, and the charge retention property are excellent.

The total amount of the charge transport material may be 60% by mass or more, or 60% by mass or more and 75% by mass or less with respect to the total solid content of the undercoat layer, excluding the silica particles. In a case where the content of the electron transport material is 75% by mass or less, degradation of the film quality, a decrease in film forming properties, and occurrence of surface roughness on the undercoat layer are suppressed, and thus the charge retention property is more excellent. On the other hand, in a case where the content of the electron transport material is 60% by mass or more, sufficient electron transportability is exhibited, and thus the suppression of the leakage current and the suppression of the accumulation of the residual potential are more excellent. In addition, the charge retention property is sufficiently ensured.

### Binder Resin

Examples of the binder resin include known polymer compounds such as an acetal resin (for example, polyvinyl butyral or the like), a polyvinyl alcohol resin, a polyvinyl acetal resin, a casein resin, a diallyl phthalate resin, a polyamide resin, a nylon resin, a nylon polyamide resin, a cellulose resin, gelatin, a urethane resin, a melamine resin, a benzoguanamine resin (for example, a methylated benzoguanamine resin or the like), a polyester resin, an unsaturated polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a urea resin, a phenol resin (for example, a resol type phenol resin or the like), a phenol-formaldehyde resin, an alkyd resin, and an epoxy resin; a zirconium chelate compound; a titanium chelate compound; an aluminum chelate compound; a titanium alkoxide compound; an organic titanium compound; and known materials such as a silane coupling agent.

Examples of the binder resin also include a charge-transporting resin having a charge-transporting group, and a conductive resin (for example, polyaniline or the like).

In the present specification, the binder resin includes a resin obtained by a reaction between the resin described above and a curing agent, and also includes a resin obtained by a reaction of a curing agent.

In the present specification, a resin obtained by a reaction between a urethane resin and a curing agent will be referred to as “curable urethane resin” for convenience.

The binder resin may be a thermoplastic resin or a thermosetting resin, and for example, a thermosetting resin is preferable. From the viewpoint that dissolution or swelling of a film does not occur in the formation of a coating film of an upper layer, for example, it is preferable that the binder resin is a thermosetting resin.

Among the above, as the binder resin used for the undercoat layer, for example, a resin insoluble in a coating solvent of the upper layer is suitable. The binder resin used for the undercoat layer is, for example, preferably a resin obtained by a reaction between at least one resin selected from the group consisting of a diallyl phthalate resin, a polyamide resin, a nylon resin, a urethane resin, a melamine resin, a benzoguanamine resin, and a phenol resin and a curing agent; and more preferably includes at least one resin selected from the group consisting of a urethane resin, a melamine resin, and a benzoguanamine resin. In a case where the binder resin includes at least one resin selected from the above-described group, blocking property of holes is high, and the charge retention property is more excellent.

A proportion of at least one resin selected from the group consisting of a urethane resin, a melamine resin, and a benzoguanamine resin in the total amount of the binder resin in the undercoat layer is, for example, preferably 80% by mass or more and 100% by mass or less, more preferably 90% by mass or more and 100% by mass or less, and still more preferably 95% by mass or more and 100% by mass or less.

The undercoat layer may contain various additives for improving the electrical properties, the environmental stability, and the image quality.

Examples of the additive include known materials, for example, an electron-transporting pigment such as a polycyclic condensed pigment or an azo-based pigment, a zirconium chelate compound, a titanium chelate compound, an aluminum chelate compound, a titanium alkoxide compound, an organic titanium compound, and a silane coupling agent. The silane coupling agent is used for the surface treatment of the inorganic particles as described above, but may be further added to the undercoat layer as the additive.

Examples of the silane coupling agent as the additive include vinyltrimethoxysilane, 3-methacryloxypropyl-tris(2-methoxyethoxy) silane, 2-(3,4-epoxycyclohexyl)ethyltrimethoxysilane, 3-glycidoxypropyltrimethoxysilane, vinyltriacetoxysilane, 3-mercaptopropyltrimethoxysilane, 3-aminopropyltriethoxysilane, N-2-(aminoethyl)-3-aminopropyltrimethoxysilane, N-2-(aminoethyl)-3-aminopropylmethyldimethoxysilane, N,N-bis(2-hydroxyethyl)-3-aminopropyltriethoxysilane, and 3-chloropropyltrimethoxysilane.

Examples of the zirconium chelate compound include zirconium butoxide, ethyl zirconium acetoacetate, zirconium triethanolamine, acetylacetonate zirconium butoxide, ethyl zirconium butoxide acetoacetate, zirconium acetate, zirconium oxalate, zirconium lactate, zirconium phosphonate, zirconium octanoate, zirconium naphthenate, zirconium laurate, zirconium stearate, zirconium isostearate, zirconium butoxide methacrylate, stearate zirconium butoxide, and isostearate zirconium butoxide.

Examples of the titanium chelate compound include tetraisopropyl titanate, tetranormal butyl titanate, a butyl titanate dimer, tetra(2-ethylhexyl) titanate, titanium acetylacetonate, polytitanium acetylacetonate, titanium octylene glycolate, titanium lactate ammonium salt, titanium lactate, titanium lactate ethyl ester, titanium triethanol aminate, and polyhydroxy titanium stearate.

Examples of the aluminum chelate compound include aluminum isopropylate, monobutoxyaluminum diisopropylate, aluminum butyrate, diethylacetoacetate aluminum diisopropylate, and aluminum tris(ethylacetoacetate).

These additives may be used alone or in a form of a mixture or a polycondensate of a plurality of compounds.

The undercoat layer may have, for example, a Vickers hardness of 35 or more.

For example, the surface roughness (ten-point average roughness) of the undercoat layer may be adjusted to ½ from 1/(4n)(n represents a refractive index of an upper layer) of a laser wavelength λ for exposure to be used to suppress moire fringes.

Resin particles or the like may be added to the undercoat layer to adjust the surface roughness. Examples of the resin particles include silicone resin particles and crosslinked polymethyl methacrylate resin particles. In addition, the surface of the undercoat layer may be polished to adjust the surface roughness. Examples of a polishing method include buff polishing, a sandblast treatment, wet honing, and a grinding treatment.

The formation of the undercoat layer is not particularly limited, and a known forming method is used. For example, a coating film of a coating solution for forming the undercoat layer, in which the above-described components are added to a solvent, is formed, and the coating film is dried and then heated as necessary.

Examples of the solvent for preparing the coating solution for forming the undercoat layer include known organic solvents such as an alcohol-based solvent, an aromatic hydrocarbon solvent, a halogenated hydrocarbon solvent, a ketone-based solvent, a ketone alcohol-based solvent, an ether-based solvent, and an ester-based solvent.

Specific examples of the solvent include typical organic solvents such as methanol, ethanol, n-propanol, iso-propanol, n-butanol, benzyl alcohol, methyl cellosolve, ethyl cellosolve, acetone, methyl ethyl ketone, cyclohexanone, methyl acetate, ethyl acetate, n-butyl acetate, dioxane, tetrahydrofuran, methylene chloride, chloroform, chlorobenzene, and toluene.

Examples of the method of dispersing the inorganic particles in a case of preparing the coating solution for forming the undercoat layer include known methods such as a roll mill, a ball mill, a vibration ball mill, an attritor, a sand mill, a colloid mill, and a paint shaker.

Examples of the method of coating the conductive substrate with the coating solution for forming the undercoat layer include typical coating methods such as a blade coating method, a wire bar coating method, a spray coating method, a dip coating method, a bead coating method, an air knife coating method, and a curtain coating method.

### Conductive Substrate

Examples of the conductive substrate include metal plates, metal drums, metal belts, or the like, containing a metal (such as aluminum, copper, zinc, chromium, nickel, molybdenum, vanadium, indium, gold, and platinum) or an alloy (such as stainless steel). In addition, examples of the conductive substrate also include paper, a resin film, a belt, or the like, that is obtained by being coated, vapor-deposited, or laminated with a conductive compound (such as a conductive polymer and indium oxide), a metal (such as aluminum, palladium, and gold) or an alloy. Here, the term “conductive” denotes that a volume resistivity is less than 10¹³ Ω·cm.

In a case where the electrophotographic photoreceptor is used in a laser printer, for example, it is preferable that a surface of the conductive substrate is roughened such that a centerline average roughness Ra thereof is 0.04 μm or more and 0.5 μm or less for the purpose of suppressing interference fringes from occurring in a case of irradiation with laser beams. In a case where incoherent light is used as a light source, roughening of the surface to prevent the interference fringes is not particularly necessary, and it is appropriate for longer life because occurrence of defects due to the roughness of the surface of the conductive substrate is suppressed.

Examples of the roughening method include wet honing performed by suspending an abrasive in water and spraying the suspension to the conductive substrate, centerless grinding performed by pressure-welding the conductive substrate against a rotating grindstone and continuously grinding the conductive substrate, and an anodizing treatment.

Examples of the roughening method also include a method of dispersing conductive or semi-conductive powder in a resin without roughening the surface of the conductive substrate to form a layer on the surface of the conductive substrate, and performing roughening using the particles dispersed in the layer.

The roughening treatment by anodization is a treatment of forming an oxide film on the surface of the conductive substrate by carrying out anodization in an electrolytic solution using a conductive substrate made of a metal (for example, aluminum) as an anode. Examples of the electrolytic solution include a sulfuric acid solution and an oxalic acid solution. However, a porous anodized film formed by the anodization is chemically active in a natural state, is easily contaminated, and has a large resistance fluctuation depending on the environment. Therefore, for example, it is preferable that a sealing treatment is performed on the porous anodized film so that micropores of the oxide film are closed by volume expansion due to a hydration reaction in pressurized steam or boiling water (a metal salt such as nickel may be added thereto) for a change into a more stable a hydrous oxide.

A film thickness of the anodized film is, for example, preferably 0.3 μm or more and 15 μm or less. In a case where the film thickness is within the above-described range, barrier properties against injection tend to be exhibited, and an increase in the residual potential due to repeated use tends to be suppressed.

The conductive substrate may be subjected to a treatment with an acidic treatment liquid or a boehmite treatment.

The treatment with an acidic treatment liquid is carried out, for example, as follows. First, an acidic treatment liquid containing phosphoric acid, chromic acid, and hydrofluoric acid is prepared. As a blending proportion of the phosphoric acid, chromic acid, and hydrofluoric acid to the acidic treatment liquid, for example, a concentration of the phosphoric acid may be in a range of 10% by mass or more and 11% by mass or less, a concentration of the chromic acid may be in a range of 3% by mass or more and 5% by mass or less, and a concentration of the hydrofluoric acid may be in a range of 0.5% by mass or more and 2% by mass or less, and a concentration of all of these acids may be in a range of 13.5% by mass or more and 18% by mass or less. A treatment temperature is, for example, preferably 42° C. or higher and 48° C. or lower. A film thickness of the coating film is, for example, preferably 0.3 μm or more and 15 μm or less.

The boehmite treatment is carried out, for example, by dipping the base material in pure water at 90° C. or higher and 100° C. or lower for 5 minutes to 60 minutes, or by bringing the base material into contact with heated steam at 90° C. or higher and 120° C. or lower for 5 minutes to 60 minutes. A film thickness of the coating film is, for example, preferably 0.1 μm or more and 5 μm or less. The coating film may be further subjected to an anodizing treatment using an electrolytic solution having low film solubility, such as adipic acid, boric acid, a borate, a phosphate, a phthalate, a maleate, a benzoate, a tartrate, or a citrate.

### Interlayer

Although not shown in the drawings, an interlayer may be further provided between the undercoat layer and the photosensitive layer.

The interlayer is, for example, a layer containing a resin. Examples of the resin used for the interlayer include polymer compounds such as an acetal resin (for example, polyvinyl butyral or the like), a polyvinyl alcohol resin, a polyvinyl acetal resin, a casein resin, a polyamide resin, a cellulose resin, gelatin, a polyurethane resin, a polyester resin, a methacrylic resin, an acrylic resin, a polyvinyl chloride resin, a polyvinyl acetate resin, a vinyl chloride-vinyl acetate-maleic anhydride resin, a silicone resin, a silicone-alkyd resin, a phenol-formaldehyde resin, and a melamine resin.

The interlayer may be a layer containing an organometallic compound. Examples of the organometallic compound used for the interlayer include organometallic compounds containing a metal atom such as zirconium, titanium, aluminum, manganese, and silicon.

The compounds used for the interlayer may be used alone or in a form of a mixture or a polycondensate of a plurality of compounds.

Among the above, for example, it is preferable that the interlayer is a layer containing an organometallic compound containing a zirconium atom or a silicon atom.

The formation of the interlayer is not particularly limited, and a known forming method is used. For example, a coating film of a coating solution for forming the interlayer, in which the above-described components are added to a solvent, is formed, and the coating film is dried and then heated as necessary.

Examples of the coating method of forming the interlayer include typical methods such as a dip coating method, a push-up coating method, a wire bar coating method, a spray coating method, a blade coating method, an air knife coating method, and a curtain coating method.

A film thickness of the interlayer is set to, for example, preferably in a range of 0.1 μm or more and 3 μm or less. The interlayer may be used as the undercoat layer.

### Charge Generation Layer

A charge generation layer is, for example, a layer containing a charge generation material and a binder resin. In addition, the charge generation layer may be a deposition layer of the charge generation material. For example, the deposition layer of the charge generation material is suitable in a case where an incoherent light source such as a light emitting diode (LED) and an organic electro-luminescence (EL) image array is used.

Examples of the charge generation material include an azo pigment such as a bisazo pigment and a trisazo pigment; a fused ring aromatic pigment such as dibromoanthanthrone; a perylene pigment; a pyrrolopyrrole pigment; a phthalocyanine pigment; zinc oxide; and trigonal selenium.

Among the above, for example, a metal phthalocyanine pigment or a metal-free phthalocyanine pigment is preferably used as the charge generation material, in order to deal with laser exposure in a near-infrared region. Specifically, for example, hydroxy gallium phthalocyanine, chlorogallium phthalocyanine, dichlorotin phthalocyanine, or titanyl phthalocyanine is more preferable.

On the other hand, for example, a fused ring aromatic pigment such as dibromoanthanthrone; a thioindigo-based pigment; a porphyrazine compound; zinc oxide; trigonal selenium; or a bisazo pigment is preferable as the charge generation material in order to deal with laser exposure in a near-ultraviolet region.

The above-described charge generation material may be used even in a case where a non-coherent light source such as an LED having a central wavelength of light emission in a range of 450 nm or more and 780 nm or less and an organic EL image array is used.

In a case where an n-type semiconductor such as a fused ring aromatic pigment, a perylene pigment, and an azo pigment is used as the charge generation material, a dark current is unlikely to be generated, and image defects referred to as black spots can be suppressed even in a case in which a thin film is used as the photosensitive layer.

The n-type is determined by the polarity of the flowing photocurrent using a typically used time-of-flight method, and a material in which electrons more easily flow as carriers than positive holes is determined as the n-type.

The binder resin used for the charge generation layer is selected from a wide range of insulating resins, and the binder resin may be selected from organic photoconductive polymers such as poly-N-vinylcarbazole, polyvinylanthracene, polyvinylpyrene, and polysilane.

Examples of the binder resin include a polyvinyl butyral resin, a polyarylate resin (polycondensate of bisphenols and aromatic divalent carboxylic acid, or the like), a polycarbonate resin, a polyester resin, a phenoxy resin, a vinyl chloride-vinyl acetate copolymer, a polyamide resin, an acrylic resin, a polyacrylamide resin, a polyvinylpyridine resin, a cellulose resin, a urethane resin, an epoxy resin, casein, a polyvinyl alcohol resin, and a polyvinylpyrrolidone resin. Here, the term “insulating” means that a volume resistivity is 10¹³ Ω·cm or more.

The binder resins may be used alone or in a form of a mixture of two or more kinds thereof.

A blending ratio between the charge generation material and the binder resin is, for example, preferably in a range of 10:1 to 1:10 in terms of mass ratio.

The charge generation layer may also contain other known additives.

The formation of the charge generation layer is not particularly limited, and a known forming method is used. For example, a coating film of a coating solution for forming the charge generation layer, in which the above-described components are added to a solvent, is formed, and the coating film is dried and then heated as necessary. The charge generation layer may be formed by a vapor deposition of the charge generation material. For example, the formation of the charge generation layer by the vapor deposition is particularly preferable in a case where the fused ring aromatic pigment or the perylene pigment is used as the charge generation material.

Examples of the solvent for preparing the coating solution for forming the charge generation layer include methanol, ethanol, n-propanol, n-butanol, benzyl alcohol, methyl cellosolve, ethyl cellosolve, acetone, methyl ethyl ketone, cyclohexanone, methyl acetate, n-butyl acetate, dioxane, tetrahydrofuran, methylene chloride, chloroform, chlorobenzene, and toluene. The solvents are used alone or in a form of a mixture of two or more kinds thereof.

As a method of dispersing particles (for example, the charge generation material) in the coating solution for forming the charge generation layer, for example, a media disperser such as a ball mill, a vibration ball mill, an attritor, a sand mill, and a horizontal sand mill, or a medialess disperser such as a stirrer, an ultrasonic disperser, a roll mill, and a high-pressure homogenizer is used. Examples of the high-pressure homogenizer include a collision type high-pressure homogenizer in which a dispersion liquid is dispersed by a liquid-liquid collision or a liquid-wall collision in a high-pressure state, and a penetration type high-pressure homogenizer in which a dispersion liquid is dispersed by causing the dispersion liquid to penetrate through a micro-flow path in a high-pressure state.

During the dispersion, it is effective to set an average particle diameter of the charge generation material in the coating solution for forming the charge generation layer to 0.5 μm or less, for example, preferably 0.3 μm or less and more preferably 0.15 μm or less.

Examples of the method of coating the undercoat layer (or the interlayer) with the coating solution for forming the charge generation layer include typical methods such as a blade coating method, a wire bar coating method, a spray coating method, a dip coating method, a bead coating method, an air knife coating method, and a curtain coating method.

A film thickness of the charge generation layer is set to, for example, preferably in a range of 0.1 μm or more and 5.0 μm or less and more preferably in a range of 0.2 μm or more and 2.0 μm or less.

### Charge Transport Layer

A charge transport layer is, for example, a layer containing a charge transport material and a binder resin. The charge transport layer may be a layer containing a polymer charge transport material.

Examples of the charge transport material include a quinone-based compound such as p-benzoquinone, chloranil, bromanil, and anthraquinone; a tetracyanoquinodimethane-based compound; a fluorenone compound such as 2,4,7-trinitrofluorenone; a xanthone-based compound; a benzophenone-based compound; a cyanovinyl-based compound; and an electron-transporting compound such as an ethylene-based compound. Examples of the charge transport material also include a positive hole-transporting compound such as a triarylamine-based compound, a benzidine-based compound, an arylalkane-based compound, an aryl-substituted ethylene-based compound, a stilbene-based compound, an anthracene-based compound, and a hydrazone-based compound. The charge transport materials may be used alone or in combination of two or more kinds thereof, but are not limited thereto.

From the viewpoint of charge mobility, for example, a triarylamine derivative represented by Structural Formula (a-1) or a benzidine derivative represented by Structural Formula (a-2) is preferable as the charge transport material.

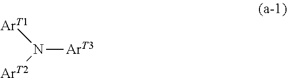

In Structural Formula (a-1), Ar^{T1}, Ar^{T2}, and Ar^{T3} each independently represent a substituted or unsubstituted aryl group, —C₆H₄—C(R^{T4})═C(R^{T5})(R^{T6}), or —C₆H₄—CH═CH—CH═C(R^{T7})(R^{T8}). R^{T4}, R^{T5}, R^{T6}, R^{T7}, and R^{T8} each independently represent a hydrogen atom, a substituted or unsubstituted alkyl group, or a substituted or unsubstituted aryl group.

Examples of the substituent of each group described above include a halogen atom, an alkyl group having 1 or more and 5 or less carbon atoms, and an alkoxy group having 1 or more and 5 or less carbon atoms. In addition, examples of the substituent of each group described above also include a substituted amino group substituted with an alkyl group having 1 or more and 3 or less carbon atoms.

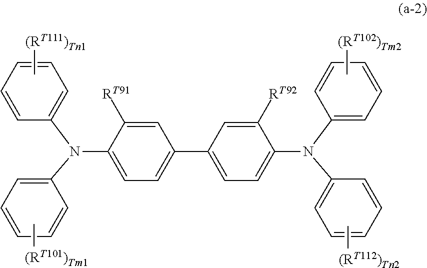

In Structural Formula (a-2), R^{T91} and R^{T92} each independently represent a hydrogen atom, a halogen atom, an alkyl group having 1 or more and 5 or less carbon atoms, or an alkoxy group having 1 or more and 5 or less carbon atoms. R^{T101}, R^{T102}, R^{T111}, and R^{T112} each independently represent a halogen atom, an alkyl group having 1 or more and 5 or less carbon atoms, an alkoxy group having 1 or more and 5 or less carbon atoms, an amino group substituted with an alkyl group having 1 or more and 2 or less carbon atoms, a substituted or unsubstituted aryl group, —C(R^{T12})═C(R^{T13})(R^{T14}), or —CH—CH—CH═C(R^{T15})(R^{T16}), in which R^{T12}, R^{T13}, R^{T14}, R^{T15}, and R^{T16} each independently represent a hydrogen atom, a substituted or unsubstituted alkyl group, or a substituted or unsubstituted aryl group. Tm1, Tm2, Tn1, and Tn2 each independently represent an integer of 0 or more and 2 or less.

Examples of the substituent of each group described above include a halogen atom, an alkyl group having 1 or more and 5 or less carbon atoms, and an alkoxy group having 1 or more and 5 or less carbon atoms. In addition, examples of the substituent of each group described above also include a substituted amino group substituted with an alkyl group having 1 or more and 3 or less carbon atoms.

Here, among the triarylamine derivative represented by Structural Formula (a-1) and the benzidine derivative represented by Structural Formula (a-2), for example, a triarylamine derivative having “—C₆H₄—CH═CH—CH═C(R^{T7})(R^{T8})” or a benzidine derivative having “—CH═CH—CH═C(R^{T15})(R^{T16})” is particularly preferable from the viewpoint of the charge mobility.

As the polymer charge transport material, known materials having charge transport properties, such as poly-N-vinylcarbazole and polysilane, are used. In particular, for example, a polyester-based polymer charge transport material is particularly preferable. The polymer charge transport material may be used alone or in combination of the binder resin.

Examples of the binder resin used for the charge transport layer include a polycarbonate resin, a polyester resin, a polyarylate resin, a methacrylic resin, an acrylic resin, a polyvinyl chloride resin, a polyvinylidene chloride resin, a polystyrene resin, a polyvinyl acetate resin, a styrene-butadiene copolymer, a vinylidene chloride-acrylonitrile copolymer, a vinyl chloride-vinyl acetate copolymer, a vinyl chloride-vinyl acetate-maleic anhydride copolymer, a silicone resin, a silicone alkyd resin, a phenol-formaldehyde resin, a styrene-alkyd resin, poly-N-vinylcarbazole, and polysilane. Among the above, for example, a polycarbonate resin or a polyarylate resin is preferable as the binder resin. The binder resins may be used alone or in combination of two or more kinds thereof.

A blending ratio between the charge transport material and the binder resin is, for example, preferably 10:1 to 1:5 in terms of mass ratio.

The charge transport layer may also contain other known additives.

The formation of the charge transport layer is not particularly limited, and a known forming method is used. For example, a coating film of a coating solution for forming the charge transport layer, in which the above-described components are added to a solvent, is formed, and the coating film is dried and then heated as necessary.

Examples of the solvent for preparing the coating solution for forming the charge transport layer include typical organic solvents, for example, aromatic hydrocarbons such as benzene, toluene, xylene, and chlorobenzene; ketones such as acetone and 2-butanone; halogenated aliphatic hydrocarbons such as methylene chloride, chloroform, and ethylene chloride; and cyclic or linear ethers such as tetrahydrofuran and ethyl ether. The solvents are used alone or in a form of a mixture of two or more kinds thereof.

Examples of the coating method of coating the charge generation layer with the coating solution for forming the charge transport layer include typical methods such as a blade coating method, a wire bar coating method, a spray coating method, a dip coating method, a bead coating method, an air knife coating method, and a curtain coating method.

A film thickness of the charge transport layer is set to, for example, preferably in a range of 5 μm or more and 50 μm or less and more preferably in a range of 10 μm or more and 30 μm or less.

### Protective Layer

A protective layer is provided on the photosensitive layer as necessary. The protective layer is provided, for example, for the purpose of preventing a chemical change in the photosensitive layer during charging and further improving a mechanical strength of the photosensitive layer.

Therefore, for example, a layer formed of a cured film (crosslinked film) may be applied to the protective layer. Examples of the layer include layers described in the items 1) and 2) below.
1) A layer formed of a cured film with a composition containing a reactive group-containing charge transport material that has a reactive group and a charge-transporting skeleton in the same molecule (that is, a layer containing a polymer or a crosslinked body of the reactive group-containing charge transport material)
2) A layer formed of a cured film with a composition containing a non-reactive charge transport material and a reactive group-containing non-charge transport material that has a reactive group and does not have a charge-transporting skeleton (that is, a layer containing the non-reactive charge transport material, and a polymer or a crosslinked body of the reactive group-containing non-charge transport material)

Examples of the reactive group of the reactive group-containing charge transport material include known reactive groups such as a chain polymerizable group, an epoxy group, —OH, —OR [here, R represents an alkyl group], —NH₂, —SH, —COOH, and —SiR^{Q1}_{3-Qn}(OR^{Q2})_{Qn} [here, R^{Q1} represents a hydrogen atom, an alkyl group, or a substituted or unsubstituted aryl group, R^{Q2} represents a hydrogen atom, an alkyl group, or a trialkylsilyl group, and Qn represents an integer of 1 to 3].

The chain polymerizable group is not particularly limited as long as the group is a functional group capable of radical polymerization, and is, for example, a functional group having a group containing at least carbon double bond. Specific examples thereof include a vinyl group, a vinyl ether group, a vinyl thioether group, a styryl group (vinylphenyl group), an acryloyl group, a methacryloyl group, and a group containing at least one selected from derivatives thereof. Among the above, from the viewpoint that reactivity is excellent, for example, a vinyl group, a styryl group (vinylphenyl group), an acryloyl group, a methacryloyl group, or a group containing at least one selected from derivatives thereof is preferable as the chain polymerizable group.

The charge-transporting skeleton of the reactive group-containing charge transport material is not particularly limited as long as the skeleton is a known structure in the electrophotographic photoreceptor, and examples thereof include a structure conjugated with a nitrogen atom, which is a skeleton derived from a nitrogen-containing positive hole-transporting compound such as a triarylamine-based compound, a benzidine-based compound, and a hydrazone-based compound. Among the above, for example, a triarylamine skeleton is preferable.

The reactive group-containing charge transport material having the reactive group and the charge-transporting skeleton, the non-reactive charge transport material, and the reactive group-containing non-charge transport material may be selected from known materials.

The protective layer may also contain other known additives.

The formation of the protective layer is not particularly limited, and a known forming method is used. For example, a coating film of a coating solution for forming the protective layer, in which the above-described components are added to a solvent, is formed, and the coating film is dried and then subjected to a curing treatment such as heating as necessary.

Examples of the solvent for preparing the coating solution for forming the protective layer include an aromatic solvent such as toluene and xylene; a ketone-based solvent such as methyl ethyl ketone, methyl isobutyl ketone, and cyclohexanone; an ester-based solvent such as ethyl acetate and butyl acetate; an ether-based solvent such as tetrahydrofuran and dioxane; a cellosolve-based solvent such as ethylene glycol monomethyl ether; and an alcohol-based solvent such as isopropyl alcohol and butanol. The solvents are used alone or in a form of a mixture of two or more kinds thereof.

The coating solution for forming the protective layer may be a solvent-less coating solution.

Examples of the method of coating the photosensitive layer (for example, the charge transport layer) with the coating solution for forming the protective layer include typical methods such as a dip coating method, a push-up coating method, a wire bar coating method, a spray coating method, a blade coating method, an air knife coating method, and a curtain coating method.

A film thickness of the protective layer is set to, for example, preferably in a range of 1 μm or more and 20 μm or less and more preferably in a range of 2 μm or more and 10 μm or less.

### Single Layer-Type Photosensitive Layer

A single layer-type photosensitive layer (charge generation/charge transport layer) is, for example, a layer containing a charge generation material, a charge transport material, and as necessary, a binder resin and other known additives. The materials are the same as the materials described in the sections of the charge generation layer and the charge transport layer.

A content of the charge generation material in the single layer-type photosensitive layer may be, for example, 0.1% by mass or more and 10% by mass or less, preferably 0.8% by mass or more and 5% by mass or less with respect to the total solid content. In addition, a content of the charge transport material in the single layer-type photosensitive layer may be, for example, 5% by mass or more and 50% by mass or less with respect to the total solid content.

A method of forming the single layer-type photosensitive layer is the same as the method of forming the charge generation layer or the charge transport layer.

A film thickness of the single layer-type photosensitive layer may be, for example, 5 μm or more and 50 μm or less, preferably 10 μm or more and 40 μm or less.

### Image Forming Apparatus (and Process Cartridge)

The image forming apparatus according to the present exemplary embodiment includes the electrophotographic photoreceptor, a charging device that charges a surface of the electrophotographic photoreceptor, an electrostatic latent image forming device that forms an electrostatic latent image on the charged surface of the electrophotographic photoreceptor, a developing device that develops the electrostatic latent image formed on the surface of the electrophotographic photoreceptor with a developer containing a toner to form a toner image, and a transfer device that transfers the toner image to a surface of a recording medium. The above-described electrophotographic photoreceptor according to the present exemplary embodiment is adopted as the electrophotographic photoreceptor.

As the image forming apparatus according to the present exemplary embodiment, a known image forming apparatus such as an apparatus including a fixing device that fixes the toner image transferred to the surface of a recording medium; a direct transfer-type apparatus that transfers the toner image formed on the surface of the electrophotographic photoreceptor directly to the recording medium; an intermediate transfer-type apparatus that primarily transfers the toner image formed on the surface of the electrophotographic photoreceptor to a surface of an intermediate transfer member and secondarily transfers the toner image transferred to the surface of the intermediate transfer member to the surface of the recording medium; an apparatus including a cleaning device that cleans the surface of the electrophotographic photoreceptor after the transfer of the toner image and before the charging; an apparatus including a charge erasing device that erases the charges on the surface of the electrophotographic photoreceptor by applying the charge erasing light after the transfer of the toner image and before the charging; or an apparatus including an electrophotographic photoreceptor heating member for increasing the temperature of the electrophotographic photoreceptor and decreasing the relative temperature is adopted.

In a case of the intermediate transfer-type apparatus, the transfer device has a configuration including an intermediate transfer member with surface on which the toner image will be transferred, a primary transfer device that performs primary transfer to transfer the toner image formed on the surface of the electrophotographic photoreceptor to the surface of the intermediate transfer member, and a secondary transfer device that performs secondary transfer to transfer the toner image transferred to the surface of the intermediate transfer member to the surface of a recording medium.

The image forming apparatus according to the present exemplary embodiment may be any of a dry development-type image forming apparatus or a wet development-type (development type using a liquid developer) image forming apparatus.

In the image forming apparatus according to the present exemplary embodiment, for example, a portion including the electrophotographic photoreceptor may have a cartridge structure (process cartridge) that is attachable to and detachable from the image forming apparatus. As the process cartridge, for example, a process cartridge including the electrophotographic photoreceptor according to the present exemplary embodiment is preferably used. The process cartridge may include, for example, at least one selected from the group consisting of a charging device, an electrostatic latent image forming device, a developing device, and a transfer device, in addition to the electrophotographic photoreceptor.

An example of the image forming apparatus according to the present exemplary embodiment will be shown below, but the present invention is not limited thereto. Hereinafter, among the parts shown in the drawing, main parts will be described, and others will not be described.

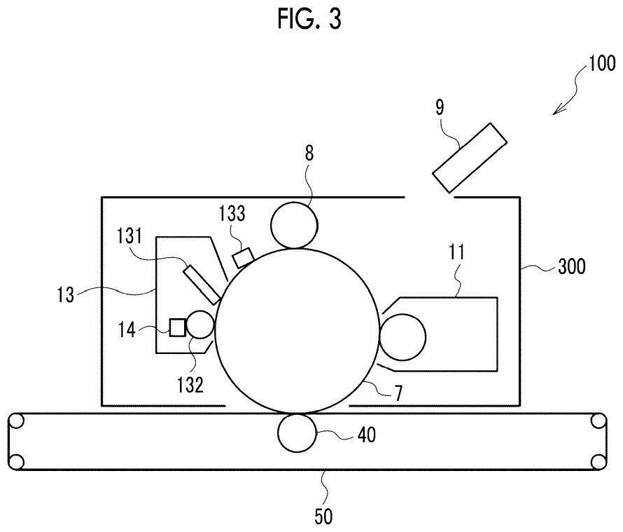

FIG. 3 is a view schematically showing a configuration of an example of the image forming apparatus according to the present exemplary embodiment.

As shown in FIG. 3, an image forming apparatus 100 according to the present exemplary embodiment includes a process cartridge 300 including an electrophotographic photoreceptor 7, an exposure device 9 (an example of the electrostatic latent image forming device), a transfer device 40 (primary transfer device), and an intermediate transfer member 50. In the image forming apparatus 100, the exposure device 9 is disposed at a position that can be exposed to the electrophotographic photoreceptor 7 from an opening portion of the process cartridge 300; the transfer device 40 is disposed at a position that faces the electrophotographic photoreceptor 7 through the intermediate transfer member 50; and the intermediate transfer member 50 is disposed such that a part of the intermediate transfer member 50 is in contact with the electrophotographic photoreceptor 7. Although not shown, the image forming apparatus also includes a secondary transfer device that transfers the toner image transferred to the intermediate transfer member 50 to a recording medium (for example, paper). The intermediate transfer member 50, the transfer device 40 (primary transfer device), and the secondary transfer device (not shown) correspond to an example of the transfer device.

The process cartridge 300 in FIG. 3 integrally supports the electrophotographic photoreceptor 7, a charging device 8 (an example of the charging device), a developing device 11 (an example of the developing device), and a cleaning device 13 (an example of the cleaning device) in a housing. The cleaning device 13 has a cleaning blade (an example of a cleaning member) 131, and the cleaning blade 131 is disposed to come into contact with the surface of the electrophotographic photoreceptor 7. The cleaning member may be a conductive or insulating fibrous member instead of the aspect of the cleaning blade 131, and may be used alone or in combination with the cleaning blade 131.

FIG. 3 shows an example of an image forming apparatus including a fibrous member 132 (roll shape) that supplies a lubricant 14 to the surface of the electrophotographic photoreceptor 7 and a fibrous member 133 (flat brush shape) that assists the cleaning, but these are disposed as necessary.

Hereinafter, each configuration of the image forming apparatus according to the present exemplary embodiment will be described.

### Charging Device

As the charging device 8, for example, a contact-type charger formed of a conductive or semi-conductive charging roller, a charging brush, a charging film, a charging rubber blade, a charging tube, or the like is used. In addition, a known charger such as a non-contact type roller charger, and a scorotoron charger or a corotron charger using corona discharge is also used.

### Exposure Device

Examples of the exposure device 9 include an optical system device that exposes the surface of the electrophotographic photoreceptor 7 to light such as a semiconductor laser beam, LED light, and liquid crystal shutter light in a predetermined image pattern. A wavelength of the light source is within the spectral sensitivity region of the electrophotographic photoreceptor. As a wavelength of a semiconductor laser, near infrared laser, which has an oscillation wavelength in the vicinity of 780 nm, is mostly used. However, the wavelength is not limited thereto, and a laser having an oscillation wavelength of an approximately 600 nm level or a laser having an oscillation wavelength of 400 nm or more and 450 nm or less as a blue laser may also be used. In addition, a surface emission-type laser light source capable of outputting a multi-beam is also effective for forming a color image.

### Developing Device

Examples of the developing device 11 include a typical developing device that performs development in contact or non-contact with the developer. The developing device 11 is not particularly limited as long as the device has the above-described functions, and is selected depending on the purpose thereof. Examples thereof include known developing machines having a function of attaching a one-component developer or a two-component developer to the electrophotographic photoreceptor 7 using a brush, a roller, or the like. Among the above, for example, a developing roller in which a developer is retained on a surface is preferably used.

The developer used in the developing device 11 may be a one-component developer containing only a toner or a two-component developer containing a toner and a carrier. In addition, the developer may be magnetic or non-magnetic. Known developers are employed as the developer.

### Cleaning Device

As the cleaning device 13, a cleaning blade-type device including the cleaning blade 131 is used.

In addition to the cleaning blade-type device, a fur brush cleaning-type device or a simultaneous development cleaning-type device may be adopted.

### Transfer Device

Examples of the transfer device 40 include a known transfer charger such as a contact type transfer charger using a belt, a roller, a film, a rubber blade, or the like, and a scorotron transfer charger or a corotron transfer charger using corona discharge.

### Intermediate Transfer Member

As the intermediate transfer member 50, a semi-conductive belt-like intermediate transfer member (intermediate transfer belt) containing polyimide, polyamide-imide, polycarbonate, polyarylate, polyester, rubber, or the like is used. In addition, as the form of the intermediate transfer member, a drum-like intermediate transfer member may be used in addition to the belt-like intermediate transfer member.

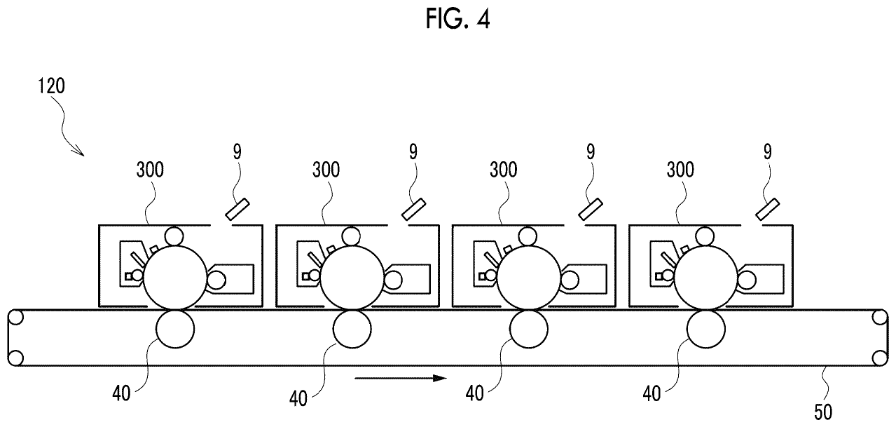

FIG. 4 is a view schematically showing a configuration of another example of the image forming apparatus according to the present exemplary embodiment.

An image forming apparatus 120 shown in FIG. 4 is a tandem type multicolor image forming apparatus in which four process cartridges 300 are mounted. The image forming apparatus 120 is formed such that the four process cartridges 300 are arranged in parallel on the intermediate transfer member 50, and one electrophotographic photoreceptor is used for each color. The image forming apparatus 120 has the same configuration as the image forming apparatus 100, except that the image forming apparatus 120 is of a tandem type.

### EXAMPLES

Hereinafter, exemplary embodiments of the invention will be specifically described based on examples. However, the exemplary embodiments of the invention are not limited to the examples.

In the following description, unless otherwise specified, “parts” and “%” are based on mass.

In the following description, the synthesis, the production, the treatment, the measurement, and the like are carried out at room temperature (25° C.±3° C.), unless otherwise specified.

### Preparation of First Undercoat Layer

### Production of First Undercoat Layer 1

25 parts by mass of an electron transport material (1-1) is mixed into a solution obtained by dissolving 14 parts by mass of a curable urethane resin (blocked isocyanate CORONATE 2507, manufactured by Tosoh Corporation, solid content: 80%) and 5.1 parts by mass of a butyral resin (S-LEC BL-S, manufactured by Sekisui Chemical Co., Ltd.) in 160 parts by mass of methyl ethyl ketone, and the mixture is subjected to a dispersion treatment for 200 minutes with a sand mill using glass beads having a diameter of 1 mmφ, thereby obtaining a dispersion.

The glass beads are separated by filtration, and 0.005 parts by mass of bismuth carboxylate (K-KAT XK-640) manufactured by King Industries, Inc. is added to the obtained dispersion as a catalyst, thereby obtaining a coating solution for forming an undercoat layer. An aluminum base material (conductive substrate) is dipped in and coated with the coating solution by a dip coating method, and dried and cured at 160° C. for 60 minutes, thereby forming a first undercoat layer 1 having a thickness of 4 μm.

### Production of First Undercoat Layer 2

A first undercoat layer 2 is produced according to the same specification as in the first undercoat layer 1, except that, in the production of the first undercoat layer 1, an electron transport material having the type and amount shown in Table 1 is used instead of the electron transport material (1-1).

### Production of First Undercoat Layer 3

25 parts by mass of an electron transport material (2-1) is mixed into a solution obtained by dissolving 20 parts by mass of a benzoguanamine resin (methylated benzoguanamine resin BL-60, manufactured by Sanwa Chemical Co., Ltd., solid content: 60%) and 4.3 parts by mass of melamine (NIKALAC MW-390, manufactured by Sanwa Chemical Co., Ltd.) in 160 parts by mass of methyl ethyl ketone, and the mixture is subjected to a dispersion treatment for 180 minutes with a sand mill using glass beads having a diameter of 1 mmφ, thereby obtaining a dispersion.

The glass beads are separated by filtration, and 0.005 parts by mass of Nacure 5925 (manufactured by King Industries, Inc.) is added to the obtained dispersion as a catalyst, thereby obtaining a coating solution for forming an undercoat layer. An aluminum base material is dipped in and coated with the coating solution by a dip coating method, and dried and cured at 160° C. for 60 minutes, thereby forming a first undercoat layer 3 having a thickness of 4 μm.

### Production of First Undercoat Layer 4

A first undercoat layer 4 is produced in the same manner as in the first undercoat layer 3, except that, in the production of the first undercoat layer 3, an electron transport material having the type and amount shown in Table 1 is used instead of the electron transport material (2-1).

### Production of First Undercoat Layer 5

25 parts by mass of an electron transport material having the type shown in Table 1 is mixed into a solution obtained by dissolving 30 parts by mass of a phenol resin (PR-53123, manufactured by Sumitomo Bakelite Co., Ltd., solid content: 45%) and 2.8 parts by mass of a butyral resin (S-LEC BM-1, manufactured by Sekisui Chemical Co., Ltd.) in a mixed solvent of 100 parts by mass of methyl ethyl ketone and 60 parts by mass of ethanol, and the mixture is subjected to a dispersion treatment for 200 minutes with a sand mill using glass beads having a diameter of 1 mmφ, thereby obtaining a dispersion. The glass beads are separated by filtration to obtain a coating solution for forming an undercoat layer. An aluminum base material is dipped in and coated with the coating solution by a dip coating method, and dried and cured at 150° C. for 60 minutes, thereby forming a first undercoat layer 5 having a thickness of 4 μm.

### Production of First Undercoat Layer 6

Each first undercoat layer is produced according to the same specification as in the first undercoat layer 1, except that the content of the silica particles in the first undercoat layer 1 is set to the content shown in Table 1 with respect to the mixture before the dispersion treatment.

### Production of First Undercoat Layers 7 to 14

Each first undercoat layer is produced according to the same specification as in the first undercoat layer 1, except that the type and amount of the charge transport material are changed as shown in Table 1.

### Production of First Undercoat Layer C1-1 for Comparative Example

A first undercoat layer C1-1 for comparison is produced in the same manner as in the first undercoat layer 1, except that silica particles (RX50, manufactured by Nippon Aerosil Co., Ltd., average particle diameter: 40 nm) are added to the mixture before the dispersion treatment so that the content thereof is as shown in Table 1.

### Production of First Undercoat Layer C1-2 for Comparative Example

A first undercoat layer C1-2 for comparison is produced in the same manner as in the first undercoat layer 1, except that the electron transport material (1-1) in the first undercoat layer 1 is changed to the following imide compound (A).

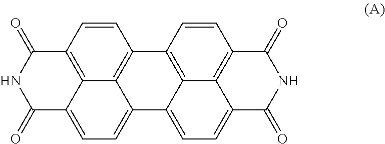 [SMILES: O=C1NC(=O)c2ccc3c4ccc5c6c(ccc(c7ccc1c2c73)c64)C(=O)NC5=O]

### Preparation of Second Undercoat Layer

Production of Second Undercoat Layer 1

20 parts by mass of an electron transport material having the type shown in Table 2 and 16.3 parts by mass of silica particles having the type shown in Table 2 (RX50, manufactured by Nippon Aerosil Co., Ltd., average particle diameter: 40 nm) are mixed into a solution obtained by dissolving 14 parts by mass of a curable urethane resin (blocked isocyanate CORONATE 2507, manufactured by Tosoh Corporation, solid content: 80%) and 5.1 parts by mass of a butyral resin (S-LEC BL-S, manufactured by Sekisui Chemical Co., Ltd.) in 200 parts by mass of methyl ethyl ketone, and the mixture is subjected to a dispersion treatment for 240 minutes with a paint shaker using glass beads having a diameter of 1 mmφ, thereby obtaining a dispersion.

The glass beads are separated by filtration, and 0.005 parts by mass of bismuth carboxylate (K-KAT XK-640) manufactured by King Industries, Inc. is added to the obtained dispersion as a catalyst, thereby obtaining a coating solution for forming an undercoat layer. An aluminum base material is dipped in and coated with the coating solution by a dip coating method, and dried and cured at 160° C. for 60 minutes, thereby forming a second undercoat layer 1 having a thickness of 3 μm.

### Production of Second Undercoat Layer 2

A second undercoat layer 2 is produced in the same manner as in the second undercoat layer 1, except that, in the production of the second undercoat layer 1, silica particles having the type shown in Table 2 (MSP-016, manufactured by TAYCA Corporation, average particle diameter: 80 nm) are used instead of the silica particles of RX50.

### Production of Second Undercoat Layer 3

A second undercoat layer 2 is produced in the same manner as in the second undercoat layer 1, except that, in the production of the second undercoat layer 1, silica particles having the type shown in Table 2 (MSL-005L, manufactured by TAYCA Corporation, average particle diameter: 80 nm) are used instead of the silica particles of RX50.

### Production of Second Undercoat Layer 4

20 parts by mass of an electron transport material (3-1) and 16.3 parts by mass of silica particles having the type shown in Table 2 (MSP-002, manufactured by TAYCA Corporation, average particle diameter: 16 nm) are mixed into a solution obtained by dissolving 20 parts by mass of a benzoguanamine resin (methylated benzoguanamine resin BL-60, manufactured by Sanwa Chemical Co., Ltd., solid content: 60%) and 4.3 parts by mass of melamine (NIKALAC MW-390, manufactured by Sanwa Chemical Co., Ltd.) in 200 parts by mass of methyl ethyl ketone, and the mixture is subjected to a dispersion treatment for 240 minutes with a paint shaker using glass beads having a diameter of 1 mmφ, thereby obtaining a dispersion.

The glass beads are separated by filtration, and 0.005 parts by mass of Nacure 5925 (manufactured by King Industries, Inc.) is added to the obtained dispersion as a catalyst, thereby obtaining a coating solution for forming an undercoat layer. An aluminum base material is dipped in and coated with the coating solution by a dip coating method, and dried and cured at 160° C. for 60 minutes, thereby forming a second undercoat layer 4 having a thickness of 3 μm.

### Production of Second Undercoat Layer 5

20 parts by mass of the electron transport material (1-1) and 16.3 parts by mass of silica particles having the type shown in Table 2 (NX90G, manufactured by Nippon Acrosil Co., Ltd., average particle diameter: 20 nm) is mixed into a solution obtained by dissolving 30 parts by mass of a phenol resin (PR-53123, manufactured by Sumitomo Bakelite Co., Ltd., solid content: 45%) and 2.8 parts by mass of a butyral resin (S-LEC BM-1, manufactured by Sekisui Chemical Co., Ltd.) in a mixed solvent of 120 parts by mass of methyl ethyl ketone and 80 parts by mass of ethanol, and the mixture is subjected to a dispersion treatment for 240 minutes with a paint shaker using glass beads having a diameter of 1 mmφ, thereby obtaining a dispersion. The glass beads are separated by filtration to obtain a coating solution for forming an undercoat layer. An aluminum base material is dipped in and coated with the coating solution by a dip coating method, and dried and cured at 150° C. for 60 minutes, thereby forming a second undercoat layer 5 having a thickness of 3 μm.

### Production of Second Undercoat Layers 6 to 11

Each second undercoat layer is produced according to the same specification as in the second undercoat layer 1, except that the type and amount of the charge transport material are changed as shown in Table 2.

### Production of Second Undercoat Layers 12 and 13

Each second undercoat layer is produced according to the same specification as in the second undercoat layer 1, except that a charge transport material having an average primary particle size and an aspect ratio as shown in Table 2 is used.

### Production of Second Undercoat Layer 14

A second undercoat layer is produced in the same specification as described above, except that, in the second undercoat layer 1, the type of silica particles is changed to the specification shown in Table 2, such that a proportion of the silica particles in a region within 50% in a direction of the conductive substrate from an interface between the second undercoat layer and the photosensitive layer (hereinafter, referred to as “IN R⁵⁰”) is the specification shown in Table 3.

### Production of Second Undercoat Layer 15

A second undercoat layer is produced in the same specification as described above, except that the type of silica particles is changed to the specification shown in Table 2, such that a proportion of the silica particles in a region exceeding 50% in a direction of the conductive substrate from an interface between the second undercoat layer and the photosensitive layer (hereinafter, referred to as “OUT R⁵⁰”) is the specification shown in Table 3.

### Production of Second Undercoat Layers 16 to 25

Each second undercoat layer is produced according to the same specification as in the second undercoat layer 1, except that the content of the silica particles is set to the specification shown in Table 2.

### Production of Second Undercoat Layer C2-1 to C2-3 for Comparative Examples

Each of second undercoat layers C2-1 to C2-3 for Comparative Examples is produced according to the same specification as in each of the first undercoat layers 1, 4, and 5, except that the silica particles are not added.

### Examples 1 to 26 and Comparative Examples 1 to 5

### Formation of Charge Generation Layer

A mixture of 15 parts by mass of hydroxygallium phthalocyanine having diffraction peaks at positions where Bragg angles (20+) 0.2° in an X-ray diffraction spectrum using Cuka characteristic X-rays are at least 7.3°, 16.0°, 24.9°, and 28.0° as a charge generation material, 10 parts by mass of vinyl chloride-vinyl acetate copolymer resin (VMCH, manufactured by Nippon Unicar Company Limited) as a binder resin, and 200 parts by mass of n-butyl acetate is stirred and dispersed in a sand mill for 4 hours using glass beads having a diameter of 1 mmφ. 175 parts by mass of n-butyl acetate and 180 parts by mass of methyl ethyl ketone are added to the obtained dispersion liquid, and the mixture is stirred, thereby obtaining a coating solution for forming a charge generation layer. The outer peripheral surface of the undercoat layer with the type shown in Table 3 is dipped and coated with the coating solution for forming a charge generation layer, and the solution is dried at 150° C. for 15 minutes, thereby forming a charge generation layer having a film thickness of 0.2 μm.

### Formation of Charge Transport Layer

38 parts by mass of the charge transport agent (HT-1) shown below, 10 parts by mass of the charge transport agent (HT-2) shown below, 52 parts by mass of the polycarbonate resin (A) (viscosity-average molecular weight: 46,000; numerical values in the structural formula represent molar ratios) shown below, and 0.3 part by mass of a fluorine-containing graft polymer (GF-500, manufactured by Toagosei Co., Ltd.) as a dispersion assistant are added to and dissolved in 800 parts by mass of tetrahydrofuran, 8 parts by mass of ethylene tetrafluoride resin (LUBRON L5, manufactured by Daikin Industries, Ltd., average particle diameter of 300 nm) is added thereto and dispersed at 5500 rpm for 2 hours using a homogenizer (ULTRA-TURRAX, manufactured by IKA Japan K.K.), thereby obtaining a coating solution for forming a charge transport layer. The charge generation layer is coated with the coating solution, and the solution is dried at 140° C. for 40 minutes, thereby forming a charge transport layer having a film thickness of 30 μm. The charge transport layer is used as an electrophotographic photoreceptor.

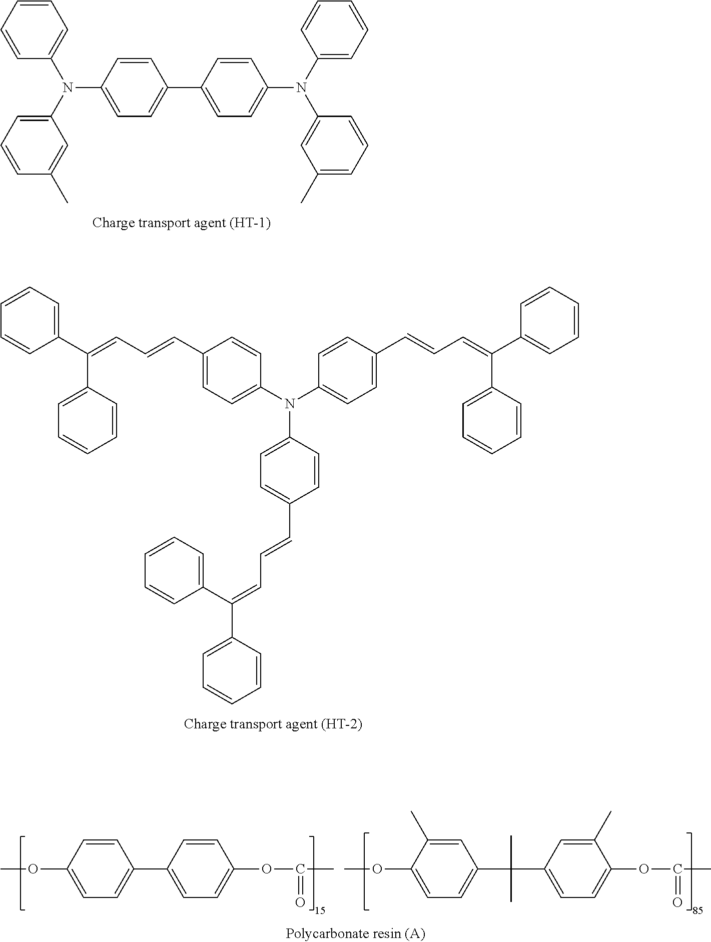

### Evaluation

The electrophotographic photoreceptor of each of Examples and Comparative Examples is mounted on a modified image forming apparatus DocuCentre C5570 (manufactured by FUJIFILM Business Innovation Corporation), and the following evaluations are performed.

### Evaluation of Accumulation of Residual Potential

An image forming test of continuously outputting 500,000 sheets of a 10% halftone image in an environment of 30° C. and 85% is performed. A residual potential on the surface of the photoreceptor immediately after the first sheet is printed and a residual potential on the surface of the photoreceptor immediately after the 500,000th sheet is printed are measured, and an increase amount is calculated from the difference therebetween. In the measurement of the residual potential, a specification is adopted in which a surface potential measuring probe is installed at a position after a static eliminator in the image forming apparatus to read the surface potential of the photoreceptor surface. The obtained increase difference of the residual potential is defined as the accumulation amount of the residual potential, and evaluated according to the following standard. The allowable range is A to D. The results are shown in the tables later.
A: less than 15 V
B: 15 V or more and less than 25 V
C: 25 V or more and less than 35 V
D: 35 V or more and less than 45 V
E: 45V or more in a problematic level

### Evaluation of Charge Retention Property

In an environment of 10° C. and 15% RH, in a case where 30,000 sheets of a 50% halftone image are printed by charging the electrophotographic photoreceptor at an applied voltage of −710 V, an initial charging potential V1 on an outer peripheral surface of the electrophotographic photoreceptor before image output (that is, a charging potential before image output) and a charging potential V2 on the outer peripheral surface of the electrophotographic photosensitive body after image output (that is, a potential on the surface of the photoreceptor immediately after a charging process) are measured. Next, a difference between the potentials V1-V2 is calculated, and evaluated according to the following standard. The allowable range is A to D. The results are shown in the tables later.
A: less than 20 V
B: 20 V or more and less than 25 V
C: 25 V or more and less than 30 V
D: 30 V or more and less than 35 V
E: 35V or more in a problematic level

### Evaluation of Leakage Current

Suppression of foreign substance from being stuck is evaluated using a phenomenon in which a current flows and dot-like image defects are generated in a case where carbon fibers penetrate through the photosensitive layer and the undercoat layer and reach the conductive substrate. Here, the charging potential is typically set to −760 V. Carbon fibers (average diameter of 7 μm, average length of 30 μm) are mixed with the developer in an amount set such that the density reaches 0.2% by mass, and 20,000 sheets of images with a density of 20% are continuously output on A4 paper. Next, 10 sheets of images with a density of 20% are output on A4 paper. The presence or absence of dot-like image defects in the image of the 10th sheet is visually observed, and the degree of image defects is classified into A to E described below. The allowable range is A to D. The results are shown in the tables later.
A: dot-like image defects are not observed.
B: number of dot-like image defects is less than 3.
C: number of dot-like image defects is less than 5.
D: number of dot-like image defects is 5 or more and less than 10.
E: number of dot-like image defects is 10 or more in a problematic level.

TABLE 1
First undercoat layer

| | Silica particles | | | Electron transport material | | | |
|---|---|---|---|---|---|---|---|
| | | Average | | | | Average | |
| | | primary | | | | primary | |
| | Content | particle | Binder resin | | | particle | Aspect |
| | % by | size | Type | Type | Content | size | ratio |
| Type | mass | nm | — | — | % by mass | nm | — |
| 1 | 0 | — | Curable urethane resin | 3-1 | 60 | 150 | 2.5 |
| 1 | 0 | — | Curable urethane resin | 3-1 | 60 | 150 | 2.5 |
| 1 | 0 | — | Curable urethane resin | 3-1 | 60 | 150 | 2.5 |
| 2 | 0 | — | Curable urethane resin | 1-1 | 60 | 160 | 4.5 |
| 3 | 0 | — | Benzoguanamine resin | 2-1 | 60 | 200 | 2.9 |
| 4 | 0 | — | Benzoguanamine resin | 3-1 | 60 | 150 | 2.5 |
| 5 | 0 | — | Phenol resin | 3-1 | 60 | 150 | 2.5 |
| 1 | 0 | — | Curable urethane resin | 3-1 | 60 | 150 | 2.5 |
| 1 | 0 | — | Curable urethane resin | 3-1 | 60 | 150 | 2.5 |
| 1 | 0 | — | Curable urethane resin | 3-1 | 60 | 150 | 2.5 |
| 1 | 0 | 0 | Curable urethane resin | 3-1 | 60 | 150 | 2.5 |
| 3 | 0 | — | Benzoguanamine resin | 2-1 | 60 | 200 | 2.9 |
| 5 | 0 | — | Phenol resin | 3-1 | 60 | 150 | 2.5 |
| C1-1 | 10 | 40 | Curable urethane resin | 3-1 | 50 | 150 | 2.5 |
| C1-2 | 0 | — | Curable urethane resin | A | 60 | 160 | 3.0 |
| 6 | 3 | 40 | Curable urethane resin | 3-1 | 60 | 150 | 2.5 |
| 6 | 3 | 40 | Curable urethane resin | 3-1 | 60 | 150 | 2.5 |
| 7 | 0 | — | Curable urethane resin | 3-8 | 65 | 200 | 2.1 |
| 8 | 0 | — | Curable urethane resin | 3-9 | 60 | 210 | 3.0 |
| 9 | 0 | — | Curable urethane resin | 3-10 | 60 | 190 | 3.0 |
| 10 | 0 | — | Curable urethane resin | 3-16 | 65 | 140 | 3.1 |
| 11 | 0 | — | Curable urethane resin | 3-12 | 60 | 250 | 2.4 |
| 12 | 0 | — | Curable urethane resin | 3-15 | 60 | 180 | 3.5 |
| 13 | 0 | — | Curable urethane resin | 1-6 | 60 | 140 | 3.5 |
| 14 | 0 | — | Curable urethane resin | 3-6 | 60 | 150 | 2.8 |
| 1 | 0 | — | Curable urethane resin | 3-1 | 60 | 150 | 2.5 |
| 1 | 0 | — | Curable urethane resin | 3-1 | 60 | 150 | 2.5 |
| 1 | 0 | — | Curable urethane resin | 3-1 | 60 | 150 | 2.5 |
| 1 | 0 | — | Curable urethane resin | 3-1 | 60 | 150 | 2.5 |
| 1 | 0 | — | Curable urethane resin | 3-1 | 60 | 150 | 2.5 |
| 1 | 0 | — | Curable urethane resin | 3-1 | 60 | 150 | 2.5 |
| 1 | 0 | — | Curable urethane resin | 3-1 | 60 | 150 | 2.5 |

TABLE 2
Second undercoat layer

| | Silica particles | | | Electron transport material | | | |
|---|---|---|---|---|---|---|---|
| | | Average | | | | Average | |
| | | primary | | | | primary | |
| | Content | particle | Binder resin | | Content | particle | Aspect |
| | % by | size | Type | Type | % by | size | ratio |
| Type | mass | nm | — | — | mass | nm | — |
| 1 | 31 | 40 | Curable urethane resin | 3-1 | 60 | 150 | 2.5 |
| 2 | 31 | 80 | Curable urethane resin | 3-1 | 60 | 150 | 2.5 |
| 3 | 31 | 80 | Curable urethane resin | 3-1 | 60 | 150 | 2.5 |
| 2 | 31 | 80 | Curable urethane resin | 3-1 | 60 | 150 | 2.5 |
| 3 | 31 | 80 | Curable urethane resin | 3-1 | 60 | 150 | 2.5 |
| 4 | 31 | 16 | Benzoguanamine resin | 2-1 | 60 | 150 | 2.5 |
| 5 | 31 | 20 | Phenol resin | 3-1 | 60 | 150 | 2.5 |
| 19 | 41 | 40 | Curable urethane resin | 3-1 | 60 | 150 | 2.5 |
| 19 | 41 | 40 | Curable urethane resin | 3-1 | 60 | 150 | 2.5 |
| 20 | 45 | 40 | Curable urethane resin | 3-1 | 60 | 150 | 2.5 |
| C2-1 | 0 | — | Curable urethane resin | 3-1 | 60 | 150 | 2.5 |
| C2-2 | 0 | — | Benzoguanamine resin | 3-1 | 60 | 200 | 2.9 |
| C2-3 | 0 | — | Phenol resin | 3-1 | 60 | 150 | 2.5 |
| 21 | 50 | 40 | Curable urethane resin | 3-1 | 60 | 150 | 2.5 |
| 1 | 31 | 40 | Curable urethane resin | 3-1 | 60 | 150 | 2.5 |
| 22 | 60 | 80 | Curable urethane resin | 3-1 | 60 | 150 | 2.5 |
| 23 | 22 | 80 | Curable urethane resin | 3-1 | 60 | 150 | 2.5 |
| 6 | 31 | 40 | Curable urethane resin | 3-8 | 65 | 200 | 2.1 |
| 7 | 31 | 40 | Curable urethane resin | 3-9 | 60 | 210 | 3.0 |
| 8 | 31 | 40 | Curable urethane resin | 3-10 | 60 | 190 | 3.0 |
| 9 | 31 | 40 | Curable urethane resin | 3-16 | 65 | 140 | 3.1 |
| 10 | 31 | 40 | Curable urethane resin | 3-12 | 60 | 250 | 2.4 |
| 11 | 31 | 40 | Curable urethane resin | 3-15 | 60 | 180 | 3.5 |
| 24 | 31 | 40 | Curable urethane resin | 1-6 | 60 | 140 | 3.5 |
| 25 | 31 | 40 | Curable urethane resin | 3-6 | 60 | 150 | 2.8 |
| 12 | 31 | 40 | Curable urethane resin | 3-1 | 60 | 120 | 4.0 |
| 13 | 31 | 40 | Curable urethane resin | 3-1 | 60 | 1 | 1.1 |
| 14 | 31 | 550 | Curable urethane resin | 3-1 | 60 | 150 | 2.5 |
| 15 | 31 | 25 | Curable urethane resin | 3-1 | 60 | 150 | 2.5 |
| 16 | 15 | 40 | Curable urethane resin | 3-1 | 60 | 150 | 2.5 |
| 17 | 22 | 40 | Curable urethane resin | 3-1 | 60 | 150 | 2.5 |
| 18 | 55 | 40 | Curable urethane resin | 3-1 | 60 | 150 | 2.5 |

TABLE 3

| | | | Entire undercoat | | | | |
|---|---|---|---|---|---|---|---|
| | | | layer | | Evaluation | | |
| | First | Second | IN | OUT | | Evaluation | Evaluation |
| | undercoat | undercoat | R50 | R50 | Evaluation | of accumulation | of charge |
| | layer | layer | % by | % by | of leakage | of residual | retention |
| | Type | Type | area | area | current | potential | property |
| Example 1 | 1 | 1 | 30 | 0 | A | A | A |
| Example 2 | 1 | 2 | 30 | 0 | A | A | A |
| Example 3 | 1 | 3 | 30 | 0 | A | A | A |
| Example 4 | 2 | 2 | 30 | 0 | A | A | B |
| Example 5 | 3 | 3 | 30 | 0 | A | A | B |
| Example 6 | 4 | 4 | 30 | 0 | A | A | A |
| Example 7 | 5 | 5 | 30 | 0 | B | B | A |
| Example 8 | 1 | 19 | 40 | 0 | A | A | B |
| Example 9 | 1 | 19 | 40 | 0 | A | A | B |
| Example 10 | 1 | 20 | 40 | 0 | A | A | B |
| Comparative | 1 | C2-1 | 0 | 0 | E | B | A |
| Example 1 | | | | | | | |
| Comparative | 3 | C2-2 | 0 | 0 | E | B | A |
| Example 2 | | | | | | | |
| Comparative | 5 | C2-3 | 0 | 0 | E | B | B |
| Example 3 | | | | | | | |
| Comparative | C1-1 | 21 | 45 | 5 | A | C | E |
| Example 4 | | | | | | | |
| Comparative | C1-2 | 1 | 30 | 0 | A | A | E |
| Example 5 | | | | | | | |
| Example 11-1 | 6 | 22 | 70 | 2 | B | B | A |
| Example 11-2 | 6 | 23 | 20 | 2 | B | B | A |
| Example 12 | 7 | 6 | 30 | 0 | A | A | B |
| Example 13 | 8 | 7 | 30 | 0 | A | A | B |
| Example 14 | 9 | 8 | 30 | 0 | A | A | C |
| Example 15 | 10 | 9 | 30 | 0 | A | A | C |
| Example 16 | 11 | 10 | 30 | 0 | A | A | C |
| Example 17 | 12 | 11 | 30 | 0 | A | A | C |
| Example 18 | 13 | 24 | 30 | 0 | A | A | C |
| Example 19 | 14 | 25 | 30 | 0 | A | A | C |
| Example 20 | 1 | 12 | 30 | 0 | C | A | A |
| Example 21 | 1 | 13 | 30 | 0 | C | A | A |
| Example 22 | 1 | 14 | 25 | 0 | A | C | D |
| Example 23 | 1 | 15 | 30 | 0 | B | A | C |
| Example 24 | 1 | 16 | 15 | 0 | C | A | A |
| Example 25 | 1 | 17 | 20 | 0 | B | A | A |
| Example 26 | 1 | 18 | 60 | 0 | A | C | A |

As shown in the tables, it is found that, in the electrophotographic photoreceptors of Examples, both the accumulation of the residual potential and the leakage current are suppressed, and the charge retention property is excellent, as compared with the electrophotographic photoreceptors of Comparative Examples.

The electrophotographic photoreceptor, the process cartridge, and the image forming apparatus according to the present disclosure include the following aspects. Each formula is the same as the formula having the same number described above.
(((1))) An electrophotographic photoreceptor comprising:
a conductive substrate;
a first undercoat layer that is provided on the conductive substrate;
a second undercoat layer that is provided on the first undercoat layer; and
a photosensitive layer that is provided on the second undercoat layer, wherein the first undercoat layer contains at least one electron transport material selected from the group consisting of a compound represented by Formula (1), a compound represented Formula (2), and a compound represented by Formula (3), and a binder resin, and a content of silica particles in the first undercoat layer is 0% by mass or 5% by mass or less, and
the second undercoat layer contains at least one electron transport material selected from the group consisting of the compound represented by Formula (1), the compound represented Formula (2), and the compound represented by Formula (3), silica particles, and a binder resin, and a content of the silica particles in the second undercoat layer is larger than the content of the silica particles in the first undercoat layer,

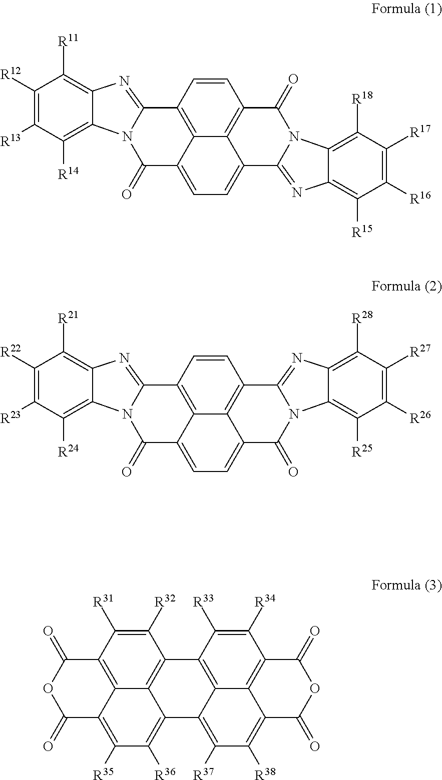

in Formula (1), R¹¹, R¹², R¹³, R¹⁴, R¹⁵, R¹⁶, R¹⁷, and R¹⁸ each independently represent a hydrogen atom, an alkyl group, an alkoxy group, an aralkyl group, an aryl group, an aryloxy group, an alkoxycarbonyl group, an aryloxycarbonyl group, an alkoxycarbonylalkyl group, an aryloxycarbonylalkyl group, or a halogen atom, R¹¹ and R¹², R¹² and R¹³, or R¹³ and R¹⁴ may be each independently linked to each other to form a ring, and R¹⁵ and R¹⁶, R¹⁶ and R¹⁷, or R¹⁷ and R¹⁸ may be each independently linked to each other to form a ring,
in Formula (2), R²¹, R²², R²³, R²⁴, R²⁵, R²⁶, R²⁷, and R²⁸ each independently represent a hydrogen atom, an alkyl group, an alkoxy group, an aralkyl group, an aryl group, an aryloxy group, an alkoxycarbonyl group, an aryloxycarbonyl group, an alkoxycarbonylalkyl group, an aryloxycarbonylalkyl group, or a halogen atom, R²¹ and R²², R²² and R²³, or R²³ and R²⁴ may be each independently linked to each other to form a ring, and R²⁵ and R²⁶, R²⁶ and R²⁷, or R²⁷ and R²⁸ may be each independently linked to each other to form a ring,
in Formula (3), R³¹, R³², R³³, R³⁴, R³⁵, R³⁶, R³⁷, and R³⁸ each independently represent a hydrogen atom, an alkyl group, an alkoxy group, an aralkyl group, an aryl group, an alkoxycarbonyl group, or a halogen atom.
(((2))) The electrophotographic photoreceptor according to (((1))),
wherein the content of the silica particles in the second undercoat layer is 20% by mass or more.
(((3))) The electrophotographic photoreceptor according to (((2))),
wherein the content of the silica particles in the second undercoat layer is 25% by mass or more and 50% by mass or less.
(((4))) An electrophotographic photoreceptor comprising:
a conductive substrate;
a specific undercoat layer that is provided on the conductive substrate; and
a photosensitive layer that is provided on the specific undercoat layer,
wherein the specific undercoat layer contains at least one electron transport material selected from the group consisting of a compound represented by Formula (1), a compound represented by Formula (2), and a compound represented by Formula (3), silica particles, and a binder resin, and
the silica particles are unevenly distributed in a region within 50% in a direction of the conductive substrate from an interface between the specific undercoat layer and the photosensitive layer,

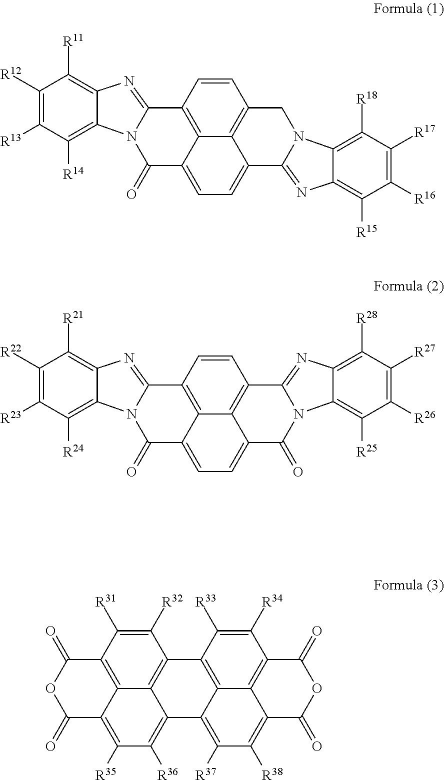

in Formula (1), R¹¹, R¹², R¹³, R¹⁴, R¹⁵, R¹⁶, R¹⁷, and R¹⁸ each independently represent a hydrogen atom, an alkyl group, an alkoxy group, an aralkyl group, an aryl group, an aryloxy group, an alkoxycarbonyl group, an aryloxycarbonyl group, an alkoxycarbonylalkyl group, an aryloxycarbonylalkyl group, or a halogen atom, R¹¹ and R¹², R¹² and R¹³, or R¹³ and R¹⁴ may be each independently linked to each other to form a ring, and R¹⁵ and R¹⁶, R¹⁶ and R¹⁷, or R¹⁷ and R¹⁸ may be each independently linked to each other to form a ring,
in Formula (2), R²¹, R²², R²³, R²⁴, R²⁵, R²⁶, R²⁷, and R²⁸ each independently represent a hydrogen atom, an alkyl group, an alkoxy group, an aralkyl group, an aryl group, an aryloxy group, an alkoxycarbonyl group, an aryloxycarbonyl group, an alkoxycarbonylalkyl group, an aryloxycarbonylalkyl group, or a halogen atom, R²¹ and R²², R²² and R²³, or R²³ and R²⁴ may be each independently linked to each other to form a ring, and R²⁵ and R²⁶, R²⁶ and R²⁷, or R²⁷ and R²⁸ may be each independently linked to each other to form a ring,
in Formula (3), R³¹, R³², R³³, R³⁴, R³⁵, R³⁶, R³⁷, and R³⁸ each independently represent a hydrogen atom, an alkyl group, an alkoxy group, an aralkyl group, an aryl group, an alkoxycarbonyl group, or a halogen atom.
(((5))) The electrophotographic photoreceptor according to (((4))),
wherein, in a cross section in a thickness direction of the specific undercoat layer, a proportion of the silica particles in the region within 50% in the direction of the conductive substrate from the interface between the specific undercoat layer and the photosensitive layer is 25% by area or more and 60% by area or less with respect to an entire specific undercoat layer.
(((6))) The electrophotographic photoreceptor according to (((5))),
wherein, in the cross section in the thickness direction of the specific undercoat layer, the proportion of the silica particles in the region within 50% in the direction of the conductive substrate from the interface between the specific undercoat layer and the photosensitive layer is 30% by area or more and 50% by area or less with respect to the entire specific undercoat layer.
(((7))) The electrophotographic photoreceptor according to any one of (((1))) to (((6))),
wherein an average primary particle size of the electron transport material is 20 nm or more and 1,000 nm or less.
(((8))) The electrophotographic photoreceptor according to any one of (((1))) to (((7))),
wherein an average primary particle size of the silica particles is 50 nm or more and 500 nm or less.
(((9))) The electrophotographic photoreceptor according to (((1))) or (((4))),
wherein the electron transport material includes at least one selected from the group consisting of the compound represented by Formula (1), the compound represented by Formula (2), and the compound represented by Formula (3), (where in Formula (1), R¹¹, R¹², R¹³, R¹⁴, R¹⁵, R¹⁶, R¹⁷, and R¹⁸ each independently represent a hydrogen atom, an alkyl group, or a halogen atom, in Formula (2), R²¹, R²², R²³, R²⁴, R²⁵, R²⁶, R²⁷, and R²⁸ each independently represent a hydrogen atom, an alkyl group, or a halogen atom, and in Formula (3), R³¹, R³², R³³, R³⁴, R³⁵, R³⁶, R³⁷, and R³⁸ each independently represent a hydrogen atom, an alkyl group, or a halogen atom).
(((10))) A process cartridge comprising:
the electrophotographic photoreceptor according to any one of (((1))) to (((9))),
wherein the process cartridge is attachable to and detachable from an image forming apparatus.
(((11))) An image forming apparatus comprising:
the electrophotographic photoreceptor according to any one of (((1))) to (((9)));
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrophotographic photoreceptor comprising:
a conductive substrate;
a first undercoat layer that is provided on the conductive substrate;
a second undercoat layer that is provided on the first undercoat layer; and
a photosensitive layer that is provided on the second undercoat layer,
wherein the first undercoat layer contains at least one electron transport material selected from the group consisting of a compound represented by Formula (1), a compound represented Formula (2), and a compound represented by Formula (3), and a binder resin, and a content of silica particles in the first undercoat layer is 0% by mass or 5% by mass or less, and
the second undercoat layer contains at least one electron transport material selected from the group consisting of the compound represented by Formula (1), the compound represented Formula (2), and the compound represented by Formula (3), silica particles, and a binder resin, and a content of the silica particles in the second undercoat layer is larger than the content of the silica particles in the first undercoat layer, 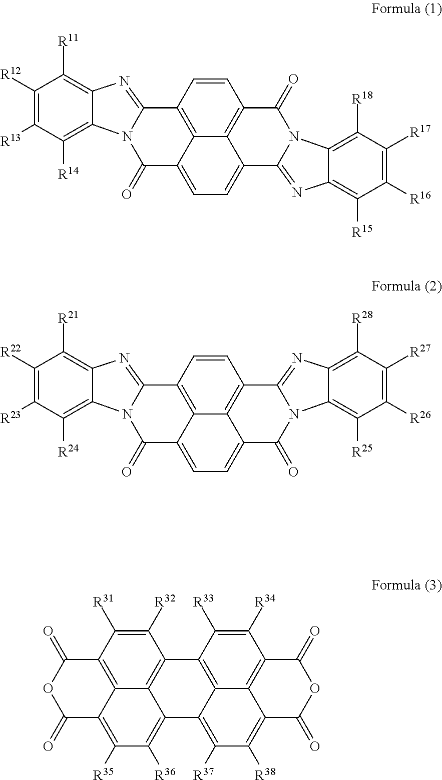
in Formula (1), R¹¹, R¹², R¹³, R¹⁴, R¹⁵, R¹⁶, R¹⁷, and R¹⁸ each independently represent a hydrogen atom, an alkyl group, an alkoxy group, an aralkyl group, an aryl group, an aryloxy group, an alkoxycarbonyl group, an aryloxycarbonyl group, an alkoxycarbonylalkyl group, an aryloxycarbonylalkyl group, or a halogen atom, R¹¹ and R¹², R¹² and R¹³, or R¹³ and R¹⁴ may be each independently linked to each other to form a ring, and R¹⁵ and R¹⁶, R¹⁶ and R¹⁷, or R¹⁷ and R¹⁸ may be each independently linked to each other to form a ring,
in Formula (2), R²¹, R²², R²³, R²⁴, R²⁵, R²⁶, R²⁷, and R²⁸ each independently represent a hydrogen atom, an alkyl group, an alkoxy group, an aralkyl group, an aryl group, an aryloxy group, an alkoxycarbonyl group, an aryloxycarbonyl group, an alkoxycarbonylalkyl group, an aryloxycarbonylalkyl group, or a halogen atom, R²¹ and R²², R²² and R²³, or R²³ and R²⁴ may be each independently linked to each other to form a ring, and R²⁵ and R²⁶, R²⁶ and R²⁷, or R²⁷ and R²⁸ may be each independently linked to each other to form a ring,
in Formula (3), R³¹, R³², R³³, R³⁴, R³⁵, R³⁶, R³⁷, and R³⁸ each independently represent a hydrogen atom, an alkyl group, an alkoxy group, an aralkyl group, an aryl group, an alkoxycarbonyl group, or a halogen atom.

2. The electrophotographic photoreceptor according to claim 1,
wherein the content of the silica particles in the second undercoat layer is 20% by mass or more.

3. The electrophotographic photoreceptor according to claim 2,
wherein the content of the silica particles in the second undercoat layer is 25% by mass or more and 50% by mass or less.

4. An electrophotographic photoreceptor comprising:
a conductive substrate;
a specific undercoat layer that is provided on the conductive substrate; and
a photosensitive layer that is provided on the specific undercoat layer,
wherein the specific undercoat layer contains at least one electron transport material selected from the group consisting of a compound represented by Formula (1), a compound represented by Formula (2), and a compound represented by Formula (3), silica particles, and a binder resin, and
the silica particles are unevenly distributed in a region within 50% in a direction of the conductive substrate from an interface between the specific undercoat layer and the photosensitive layer, 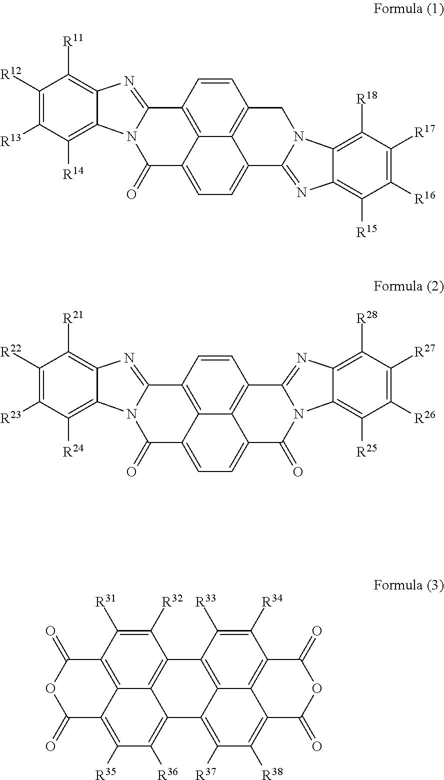
in Formula (1), R¹¹, R¹², R¹³, R¹⁴, R¹⁵, R¹⁶, R¹⁷, and R¹⁸ each independently represent a hydrogen atom, an alkyl group, an alkoxy group, an aralkyl group, an aryl group, an aryloxy group, an alkoxycarbonyl group, an aryloxycarbonyl group, an alkoxycarbonylalkyl group, an aryloxycarbonylalkyl group, or a halogen atom, R¹¹ and R¹², R¹² and R¹³, or R¹³ and R¹⁴ may be each independently linked to each other to form a ring, and R¹⁵ and R¹⁶, R¹⁶ and R¹⁷, or R¹⁷ and R¹⁸ may be each independently linked to each other to form a ring,
in Formula (2), R²¹, R²², R²³, R²⁴, R²⁵, R²⁶, R²⁷, and R²⁸ each independently represent a hydrogen atom, an alkyl group, an alkoxy group, an aralkyl group, an aryl group, an aryloxy group, an alkoxycarbonyl group, an aryloxycarbonyl group, an alkoxycarbonylalkyl group, an aryloxycarbonylalkyl group, or a halogen atom, R²¹ and R²², R²² and R²³, or R²³ and R²⁴ may be each independently linked to each other to form a ring, and R²⁵ and R²⁶, R²⁶ and R²⁷, or R²⁷ and R²⁸ may be each independently linked to each other to form a ring,
in Formula (3), R³¹, R³², R³³, R³⁴, R³⁵, R³⁶, R³⁷, and R³⁸ each independently represent a hydrogen atom, an alkyl group, an alkoxy group, an aralkyl group, an aryl group, an alkoxycarbonyl group, or a halogen atom.

5. The electrophotographic photoreceptor according to claim 4,
wherein, in a cross section in a thickness direction of the specific undercoat layer, a proportion of the silica particles in the region within 50% in the direction of the conductive substrate from the interface between the specific undercoat layer and the photosensitive layer is 25% by area or more and 60% by area or less with respect to an entire specific undercoat layer.

6. The electrophotographic photoreceptor according to claim 5,
wherein, in the cross section in the thickness direction of the specific undercoat layer, the proportion of the silica particles in the region within 50% in the direction of the conductive substrate from the interface between the specific undercoat layer and the photosensitive layer is 30% by area or more and 50% by area or less with respect to the entire specific undercoat layer.

7. The electrophotographic photoreceptor according to claim 1,
wherein an average primary particle size of the electron transport material is 20 nm or more and 1,000 nm or less.

8. The electrophotographic photoreceptor according to claim 4,
wherein an average primary particle size of the electron transport material is 20 nm or more and 1,000 nm or less.

9. The electrophotographic photoreceptor according to claim 1,
wherein an average primary particle size of the silica particles is 50 nm or more and 500 nm or less.

10. The electrophotographic photoreceptor according to claim 4,
wherein an average primary particle size of the silica particles is 50 nm or more and 500 nm or less.

11. The electrophotographic photoreceptor according to claim 1,
wherein the electron transport material includes at least one selected from the group consisting of the compound represented by Formula (1), the compound represented by Formula (2), and the compound represented by Formula (3), (where in Formula (1), R¹¹, R¹², R¹³, R¹⁴, R¹⁵, R¹⁶, R¹⁷, and R¹⁸ each independently represent a hydrogen atom, an alkyl group, or a halogen atom, in Formula (2), R²¹, R²², R²³, R²⁴, R²⁵, R²⁶, R²⁷, and R²⁸ each independently represent a hydrogen atom, an alkyl group, or a halogen atom, and in Formula (3), R³¹, R³², R³³, R³⁴, R³⁵, R³⁶, R³⁷, and R³⁸ each independently represent a hydrogen atom, an alkyl group, or a halogen atom).

12. The electrophotographic photoreceptor according to claim 4,
wherein the electron transport material includes at least one selected from the group consisting of the compound represented by Formula (1), the compound represented by Formula (2), and the compound represented by Formula (3), (where in Formula (1), R¹¹, R¹², R¹³, R¹⁴, R¹⁵, R¹⁶, R¹⁷, and R¹⁸ each independently represent a hydrogen atom, an alkyl group, or a halogen atom, in Formula (2), R²¹, R²², R²³, R²⁴, R²⁵, R²⁶, R²⁷, and R²⁸ each independently represent a hydrogen atom, an alkyl group, or a halogen atom, and in Formula (3), R³¹, R³², R³³, R³⁴, R³⁵, R³⁶, R³⁷, and R³⁸ each independently represent a hydrogen atom, an alkyl group, or a halogen atom).

13. A process cartridge comprising:
the electrophotographic photoreceptor according to claim 1,
wherein the process cartridge is attachable to and detachable from an image forming apparatus.

14. A process cartridge comprising:
the electrophotographic photoreceptor according to claim 4,
wherein the process cartridge is attachable to and detachable from an image forming apparatus.

15. An image forming apparatus comprising:
the electrophotographic photoreceptor according to claim 1;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.

16. An image forming apparatus comprising:
the electrophotographic photoreceptor according to claim 4;
a charging device that charges a surface of the electrophotographic photoreceptor;
an electrostatic latent image forming device that forms an electrostatic latent image on the charged surface of the electrophotographic photoreceptor;
a developing device that develops the electrostatic latent image formed on the surface of the electrophotographic photoreceptor with a developer containing a toner to form a toner image; and
a transfer device that transfers the toner image to a surface of a recording medium.
